(19) United States
(12) Patent Application Publication
(10) Pub. No.: US 2026/0269782 A1
(43) Pub. Date: Sep. 10, 2026

(54) MOUNTING AND FIXING SYSTEM FOR PHOTOVOLTAIC JUNCTION BOX

(71) Applicant: QC SOLAR (SUZHOU) CORPORATION, Suzhou, Jiangsu (CN)

(72) Inventors: Zhenggang DUAN, Suzhou, Jiangsu (CN); Junliu ZHOU, Suzhou, Jiangsu (CN)

(21) Appl. No.: 19/165,284

(22) PCT Filed: Mar. 13, 2024
(86) PCT No.: PCT/CN2024/081281

§ 371 Date: Sep. 15, 2025

(30) Foreign Application Priority Data
Mar. 16, 2023 (CN) 202320516139.6
Mar. 29, 2023 (CN) 202320654926.7

(51) Int. Cl. H02S 40/34; H02G 3/08; H02G 3/32

(52) U.S. Cl. CPC H02S 40/34; H02G 3/08; H02G 3/32

(57) ABSTRACT

A mounting and fixing system for photovoltaic junction box is provided, including a fixing base and a photovoltaic junction box. The photovoltaic junction box includes a box body connectable to the fixing base, the box body includes a box main body having an accommodating cavity, the fixing base includes a bottom plate, and a side blocking assembly extending upward from the bottom plate. The side blocking assembly and the bottom plate enclose a mounting space, the box main body is configured to be cooperatively accommodated in the mounting space, and the box body and the fixing base are interconnected by a snap-fit structure provided therebetween. By providing an independent fixing base, it is possible to adapt to the installation requirements of different scenarios and to conveniently install the photovoltaic junction box, while also facilitating the repair or replacement of the photovoltaic junction box.

### CROSS-REFERENCE TO RELATED APPLICATIONS

This application is a national stage of International Application No. PCT/CN2024/081281, filed on Mar. 13, 2024, which claims priority to Chinese Patent Application No. 202320516139.6, filed on Mar. 16, 2023, and Chinese Patent Application No. 202320654926.7, filed on Mar. 29, 2023, the entire contents all of which are hereby incorporated by reference.

### FIELD OF TECHNOLOGY

The following relates to the field of photovoltaic technology, and specifically to a mounting and fixing system for photovoltaic junction box.

### BACKGROUND

A photovoltaic power generation system is a power generation system that converts solar energy into electrical energy. While generating clean electricity, it can also take into account economic development and ecological protection. It is currently widely used in a variety of scenarios and is one of the important clean energy sources to replace traditional petrochemical energy, with broad development prospects.

A photovoltaic module is the basic power generation unit in a photovoltaic power generation system. In order for photovoltaic modules to form a complete power generation system, some electrical boxes (also called junction boxes) need to be installed with the photovoltaic modules. In the conventional art, some junction boxes with different functions are connected to photovoltaic modules to achieve effects such as eliminating safety hazards in the photovoltaic power generation system, monitoring the power generation status of photovoltaic modules in real time, and improving the power generation efficiency of the modules. For example, when several photovoltaic modules are connected in series to form a photovoltaic module string with a high DC voltage of 1000V or more, the uncontrollable high DC voltage becomes a safety hazard for the photovoltaic power generation system. Especially in the event of a fire, maintenance, or other emergencies, it poses a serious obstacle to accident handling and even threatens the personal safety of rescue personnel. To eliminate the aforementioned safety hazards of the photovoltaic power generation system, a photovoltaic junction box that can be rapidly shut down needs to be connected to the photovoltaic module. In an emergency or other necessary situations, the connection of the busbars between adjacent modules can be disconnected to quickly reduce the high DC voltage formed by the series connection of photovoltaic modules to a safe voltage. As another example, a smart optimizer that can monitor the power generation status of the module in real time and improve the power generation efficiency of the module can be formed by a photovoltaic junction box.

In practical applications, these junction boxes encounter different installation scenarios. Some junction boxes are installed directly on the photovoltaic modules during production, some are installed during the construction of the photovoltaic power generation system, and some are installed when retrofitting existing photovoltaic modules. How to make the junction box adaptable to the installation requirements of different scenarios while also being convenient for operators to repair or replace has always been an urgent problem for operators in this field.

### SUMMARY

An aspect relates to a new mounting and fixing system for photovoltaic junction box.

A first aspect provides a mounting and fixing system for photovoltaic junction box, comprising a fixing base and a photovoltaic junction box, wherein the photovoltaic junction box comprises a box body connectable to the fixing base, the box body comprises a box main body having an accommodating cavity, the fixing base comprises a bottom plate, and a side blocking assembly extending upward from the bottom plate, the side blocking assembly and the bottom plate enclose a mounting space, the box main body is configured to be cooperatively accommodated in the mounting space, and the box body and the fixing base are interconnected by a snap-fit structure provided therebetween.

In some embodiments, the snap-fit structure comprises one or more groups of clasping members extending in an up-down direction, the clasping members are respectively snap-fitted with the box body, wherein all the clasping members are provided on one end of the bottom plate or are separately provided on both ends of the bottom plate. In other words, the clasping members are provided on only one end of the bottom plate, or the clasping members are provided on both ends of the bottom plate, and the number of groups of clasping members provided on the end of the bottom plate where the clasping members are provided is one or more.

Optionally, the clasping members are respectively snap-fitted with the box main body, an upper portion of each of the clasping members has a first hook, and the box main body is provided with a cooperating part that can be snap-fitted with the first hook. Wherein, when the clasping members are provided on both ends of the bottom plate, the first hooks of the clasping members located on the two ends are oppositely arranged.

Optionally, the box main body comprises two side walls provided at two ends, the cooperating part is a first groove provided on the side walls, and the first hook is inserted into the first groove and abuts against a bottom wall of the first groove.

Optionally, the box main body comprises two side walls provided at two ends, the side wall comprises two side portions arranged in parallel and spaced apart, and a connecting rib connected between the two side portions, and the first hook is inserted between the two side portions and is clasped on the connecting rib.

Optionally, the box main body comprises two side walls provided at two ends, the cooperating part is a skirt structure provided on the side wall and extending outwardly in a protruding manner, or, the cooperating part is a clasping hole provided on an outer side of the side wall and recessed inwardly, or, the cooperating part is a wedge-shaped structure provided on an outer side of the side wall and protruding outwardly.

Optionally, a hook stop plate is further provided on an outer side of the clasping member, wherein the hook stop plate extends upward from the bottom plate, and the hook stop plate and the clasping member are spaced apart from each other.

Optionally, the hook stop plate and the side blocking assembly are integrally formed, and the side blocking assembly and the hook stop plate enclose a frame-shaped structure that is closed in a circumferential direction.

Optionally, the box main body has two oppositely arranged first side portions and two oppositely arranged second side portions, a length of the first side portions is greater than a length of the second side portions, and the clasping members are provided on two sides of the second side portions or on two sides of the first side portions.

In some embodiments, the box body further comprises an extension body extending away from the box main body, the extension body is provided at one or both ends of the box main body, a through hole extending in the up-down direction is formed between the extension body and the box main body, and the clasping member is configured to pass through the corresponding through hole in the up-down direction and be snap-fitted with the extension body or the box main body.

Optionally, the extension body comprises two extension parts arranged in parallel and spaced apart and a connecting part provided between the two extension parts, one end of the extension part is connected to a side wall of the box main body, and the through hole is formed between the two extension parts, the connecting part, and the box main body.

Optionally, the clasping member is snap-fitted with the extension body, wherein, when the clasping member passes through the through hole, the clasping member is snap-fitted with the connecting part.

Optionally, the clasping member has a second hook at an upper portion, and the second hook is cooperatively snap-fitted with the connecting part.

Optionally, the connecting part has an operating part, a fixing part, and a locking part connected in sequence in the up-down direction, wherein the fixing part is fixed to the extension part, the operating part and the locking part are respectively suspended on upper and lower sides of the extension part, and the clasping member is configured to be cooperatively snap-fitted with the locking part.

Optionally, the connecting part comprises a first connecting strip connected between the two extension parts, a second connecting strip extending in the up-down direction, and a third connecting strip connected between the first connecting strip and the second connecting strip, wherein an upper part, a middle part, and a lower part of the second connecting strip constitute the operating part, the fixing part, and the locking part in sequence, and the second connecting strip is located on a side of the first connecting strip facing the through hole.

Optionally, a lower end of the locking part has a third hook extending toward the through hole, and when the clasping member is snap-fitted with the connecting part, the second hook and the third hook are hooked and fixed to each other.

Optionally, the box body further comprises an extension body extending away from the box main body, the extension body is provided at one or both ends of the box main body, the clasping member is snap-fitted with the extension body, wherein the clasping member and the box main body are provided on different sides of the extension body.

Further, the extension body comprises two extension parts arranged in parallel and spaced apart and a connecting part provided between the two extension parts, one end of the extension part is connected to a side wall of the box main body, and the clasping member is snap-fitted with the connecting part.

Optionally, the box main body has two oppositely arranged first side portions and two oppositely arranged second side portions, a length of the first side portions is greater than a length of the second side portions, and the clasping members are provided on two sides of the second side portions.

In some embodiments, the snap-fit structure is provided between the box main body and the side blocking assembly, wherein the snap-fit structure comprises a first protrusion and a first recess that are cooperatively snap-fitted, one of the first protrusion and the first recess is provided on an outer side wall of the box main body and the other is provided on an inner side wall of the side blocking assembly, and when the box main body is accommodated in the mounting space, the first protrusion and the first recess are correspondingly engaged.

Optionally, the box main body has two oppositely arranged first side portions and two oppositely arranged second side portions, the first protrusion is provided on an outer wall of each of the first side portions, and the first protrusion is a protruding strip extending along a length direction of the first side portion, and the first recess is provided on the inner side wall of the side blocking assembly.

Optionally, a length of the first side portion is greater than a length of the second side portion, and along the length direction of the first side portion, there is one group or two or more spaced-apart groups of the first protrusion.

In some embodiments, the fixing base further comprises one or more first connecting parts extending upward from the bottom plate in a protruding manner, the one or more first connecting parts are located within the mounting space, when the box main body is accommodated in the mounting space, the first connecting part supports a lower part of the box main body, and the snap-fit structure is provided between the box main body and the first connecting part.

Optionally, the snap-fit structure is provided between the box main body and the first connecting part, wherein the snap-fit structure comprises a second connecting part extending downward from a bottom of the box main body in a protruding manner, the second connecting part is sleeved on the first connecting part and is snap-fitted with the first connecting part, or, the first connecting part is sleeved on the second connecting part and is snap-fitted with the second connecting part.

Optionally, a friction-increasing structure is provided on cooperating side walls of the first connecting part and the second connecting part.

Optionally, the first connecting part is provided with an insertion hole for inserting the second connecting part, one of an inner hole wall of the insertion hole and an outer peripheral wall of the second connecting part is provided with a second protrusion extending outwardly, and the other is provided with a second recess recessed inwardly, and when the second connecting part is inserted into the insertion hole, the second protrusion and the second recess are cooperatively snap-fitted;
or, the second connecting part is provided with an insertion hole for inserting the first connecting part, one of an inner hole wall of the insertion hole and an outer peripheral wall of the first connecting part is provided with a radial protrusion extending outwardly, and the other is provided with a radial recess recessed inwardly, and when the first connecting part is inserted into the insertion hole, the radial protrusion and the radial recess are cooperatively snap-fitted. In some embodiments, the snap-fit structure is provided between the side blocking assembly and the box main body and is used to snap-fit the two together.

Optionally, the snap-fit structure comprises a buckling member having a snap-fitting part, and a buckling part configured to be cooperatively snap-fitted with the snap-fitting part, one of the buckling member and the buckling part is provided on the box main body and the other is provided on the side blocking assembly, and when the box main body is accommodated in the mounting space, the buckling member is located outside the mounting space.

Optionally, the buckling member is provided on the box main body, and the buckling part is provided on the side blocking assembly, wherein the snap-fitting part is a third protrusion protruding toward the mounting space, and the buckling part is a third recess opened on the side blocking assembly.

Optionally, the buckling member extends in the up-down direction, the buckling member comprises an operating section, a fixing section, and a locking section connected in sequence in the up-down direction, the fixing section is attached to the box main body, and both the operating section and the locking section are spaced apart from an outer wall of the box main body, the snap-fitting part is provided at a lower part of the locking section, and the operating section is suspended above the box main body;
or, the buckling member extends in the up-down direction, the buckling member comprises a locking section, a fixing section, and an operating section connected in sequence in the up-down direction, the fixing section is attached to the side blocking assembly, and both the operating section and the locking section are spaced apart from an outer wall of the side blocking assembly, the snap-fitting part is provided at an upper part of the locking section, and a lower part of the operating section is suspended below the side blocking assembly.

Optionally, the box main body has two oppositely arranged first side portions and two oppositely arranged second side portions, a length of the first side portions is greater than a length of the second side portions, the snap-fit structure is provided on the first side portions, and along a length extension direction of the first side portion, there is one group or two or more mutually spaced groups of the snap-fit structure.

In some embodiments, the snap-fit structure comprises a latch movably provided on the fixing base, the latch is located outside the mounting space, and when the box main body is accommodated in the mounting space, at least a part of the latch can be buckled downward onto the box main body.

Optionally, the latch is rotatably connected to the fixing base, wherein the latch comprises a mounting part extending in the up-down direction, and a latching part extending from one side of the mounting part toward the mounting space, and the latching part can be buckled downward onto an upper part of the box main body.

Optionally, a lower part of the mounting part is rotatably connected to the fixing base about a rotation centerline extending in a horizontal direction, and the latching part is arc-shaped with the rotation centerline as a rotation center axis.

Optionally, the latching part is provided with a fourth hook, an upper part of the box main body is provided with a limiting boss, and the fourth hook can be cooperatively buckled onto the limiting boss.

Optionally, there is more than one group of latches, and when the box main body is accommodated in the mounting space, the latches can be buckled onto one side portion of the box main body.

Optionally, at least a part of the mounting part extends above the latching part.

In some embodiments, the side blocking assembly has an upward-facing upper opening, and the box main body is configured to be inserted into the mounting space through the upper opening when moving up and down relative to the fixing base.

In some other embodiments, the box main body is configured to achieve cooperation with the mounting space when moving in a horizontal direction relative to the fixing base, and the snap-fit structure is provided between the side blocking assembly and the box body.

Optionally, the box body further comprises two extension bodies separately provided at two ends of the box main body and extending away from the box main body, the side blocking assembly has an engaging slot, the engaging slot has a side opening facing one side in the horizontal direction of the fixing base, and the extension body can be cooperatively engaged in the engaging slot.

Optionally, the side blocking assembly comprises two spaced-apart side blocks, each of the side blocks is provided with the engaging slot, and when the box main body is located in the mounting space, the two extension bodies are correspondingly engaged in the two engaging slots.

Optionally, the side openings of the two engaging slots face the same side of the fixing base, and the box main body is configured to cooperate with the mounting space in the process of translating horizontally relative to the fixing base.

Optionally, each of the side blocks comprises a first side blocking part provided with the engaging slot, and a second side blocking part connected to the first side blocking part, the first side blocking part and the second side blocking part form an L-shape, wherein the box main body has two oppositely arranged first side portions and two oppositely arranged second side portions, and the second side blocking parts of the two side blocks are both located on the same side of one of the first side portions.

Optionally, a length of the first side portion is greater than a length of the second side portion, and along an extension direction of the first side portion, the box main body is located between the two first side blocking parts.

Optionally, the side openings of the two engaging slots face opposite directions, and the box main body is configured to cooperate with the mounting space in the process of rotating horizontally relative to the fixing base.

Optionally, each of the side blocks further comprises a second side blocking part connected to the first side blocking part, the first side blocking part and the second side blocking part form an L-shape, wherein the box main body has two oppositely arranged first side portions and two oppositely arranged second side portions, the second side blocking parts of the two side blocks are separately provided on different sides of the two first side portions, and a sum of lengths of the two second side blocking parts is less than a length of the first side portion.

Optionally, the extension body comprises an extension part and a connecting part provided on the extension part, one end of the extension part is connected to a side wall of the box main body and extends outward away from the box main body, an extension direction of the connecting part is perpendicular to an extension direction of the extension part, and when the engaging slot is snap-fitted with the extension body, the side blocking assembly is engaged on the extension part and is located between the box main body and the connecting part.

Optionally, the bottom plate has a central plate body located on an inner side of the side blocking assembly, and/or an extension plate body extending outward from an outer wall of the side blocking assembly.

In some embodiments, the bottom plate has an extension plate body extending outward from an outer wall of the side blocking assembly, and a plurality of reinforcing ribs are further provided between the extension plate body and the side blocking assembly.

In some embodiments, the fixing base is connected to a backsheet of a photovoltaic module, wherein a bottom surface of the bottom plate is adhesively fixed to a surface of the backsheet. A second aspect provides a rapid mounting and fixing system for a smart photovoltaic junction box, which comprises a fixing base and a smart photovoltaic junction box, the fixing base comprises a main body with an open top, the main body is provided with a cavity for accommodating a box body of the smart photovoltaic junction box, and its side is provided with a plurality of hooks for cooperatively fixing with the smart photovoltaic junction box; the smart photovoltaic junction box comprises a box body, a side of the box body is provided with an engaging structure for cooperating with the hooks, and two ends of the box body of the smart photovoltaic junction box are connected with at least one group of photovoltaic connectors via cables; a bottom surface of the fixing base is fixed to a backsheet of a photovoltaic module.

Optionally, the fixing base is a box-shaped structure with an open top or a frame-shaped structure.

Optionally, the engaging structure comprises a skirt structure protruding from a side of the box body, or a clasping hole recessed inwardly on an outer side of the box body, or a wedge-shaped structure protruding outwardly on a side of the box body.

Optionally, an outer side of the hook is provided with a hook stop plate integrally formed with the main body.

Optionally, the fixing base is an independent component, fixed to the module backsheet by adhesive.

Optionally, the fixing base and a box body of a conventional junction box are designed as a single piece, and are pre-fixed and installed on the module backsheet by adhesive.

Optionally, the smart photovoltaic junction box is a module optimizer, a rapid shutdown junction box, a smart monitoring junction box, or a microinverter.

Optionally, the conventional junction box is a three-part split junction box, comprising a left junction box, a middle junction box, and a right junction box.

Optionally, the smart photovoltaic junction box is installed above or below the left junction box, the middle junction box, or the right junction box of the split junction box, and one group of connectors of the smart photovoltaic junction box are respectively plugged into a connector connected to the left junction box and a connector connected to the right junction box.

Optionally, the fixing base is installed adjacent to the split junction box at a certain distance, or is installed in close proximity to the split junction box.

Optionally, the fixing base and the box body of the left junction box, the middle junction box, or the right junction box of the split junction box are designed as a single piece, and are pre-fixed and installed on the module backsheet by adhesive.

Optionally, the smart photovoltaic junction box is installed between the left junction box and the middle junction box of the split junction box, and one group of connectors of the smart photovoltaic junction box are respectively plugged into a connector connected to the left junction box and a connector connected to the right junction box.

Optionally, the smart photovoltaic junction box is installed between the middle junction box and the right junction box of the split junction box, and one group of connectors of the smart photovoltaic junction box are respectively plugged into a connector connected to the left junction box and a connector connected to the right junction box.

Optionally, the smart photovoltaic junction box is installed at any position on the back of the module, and one group of connectors of the smart photovoltaic junction box are respectively plugged into a connector connected to the left junction box and a connector connected to the right junction box.

A third aspect provides a mounting and fixing system for a smart photovoltaic junction box, wherein the mounting and fixing system comprises a smart photovoltaic junction box and a fixing base, the smart photovoltaic junction box comprises a box body, and connectors are connected to two ends of the box body via cables, wherein one group of connectors are respectively plugged into positive and negative connectors of a conventional junction box; the fixing base comprises a fixing base main body, two opposite sides of the fixing base main body are provided with hooks for buckling with the box body of the smart photovoltaic junction box, and the other two opposite sides are provided with recessed structures; a bottom surface of the fixing base is fixed to a backsheet of a photovoltaic module, and at a bottom of a side of the fixing base main body, a through drain port is provided.

Optionally, an outer side of the fixing base main body is provided with a plurality of reinforcing rib structures.

Optionally, at outlet holes at both ends of the box body of the smart photovoltaic junction box, ribs are provided, and when the smart photovoltaic junction box is installed with the fixing base, the hooks on the fixing base buckle with the ribs.

Optionally, the fixing base is a frame-shaped structure, and a protruding edge structure extending outward is provided at a bottom of a frame, and the fixing base is fixed to the module backsheet by adhesive on a bottom surface of the protruding edge structure.

Optionally, the fixing base is a box-shaped structure with an open top, and a bottom surface of the fixing base is fixed to the module backsheet by adhesive.

Optionally, the smart photovoltaic junction box is a module optimizer, a shutdown junction box, a smart monitoring junction box, or a microinverter.

Optionally, the conventional junction box is a three-part split junction box, comprising a left junction box, a middle junction box, and a right junction box.

Optionally, the smart photovoltaic junction box is installed above or below the left junction box, the middle junction box, or the right junction box of the split junction box, and one group of connectors of the smart photovoltaic junction box are respectively plugged into a connector connected to the left junction box and a connector connected to the right junction box.

Optionally, the fixing base is installed at a set distance from the split junction box, or is installed in close proximity to the split junction box.

Optionally, the smart photovoltaic junction box is installed between the left junction box and the middle junction box of the split junction box, or is installed between the middle junction box and the right junction box of the split junction box; one group of connectors of the smart photovoltaic junction box are respectively plugged into a connector connected to the left junction box and a connector connected to the right junction box.

Optionally, the smart photovoltaic junction box is installed at any position on the back of the module, and one group of connectors of the smart photovoltaic junction box are respectively plugged into a connector connected to the left junction box and a connector connected to the right junction box.

By applying the above technical solutions, the present disclosure has the following advantages over the conventional art: in the mounting and fixing system of the present disclosure, by providing a fixing base that is independent of the photovoltaic junction box, when connecting the photovoltaic junction box to a photovoltaic module, the fixing base can first be installed on the backsheet of the photovoltaic module, and then the box body of the photovoltaic junction box can be connected to the fixing base using a snap-fit structure. This mounting and fixing system is adaptable to different installation scenarios, and when it is necessary to repair or replace the photovoltaic junction box, the photovoltaic junction box can be conveniently and quickly removed from the fixing base.

### BRIEF DESCRIPTION

Some of the embodiments will be described in detail, with references to the following Figures, wherein like designations denote like members, wherein:

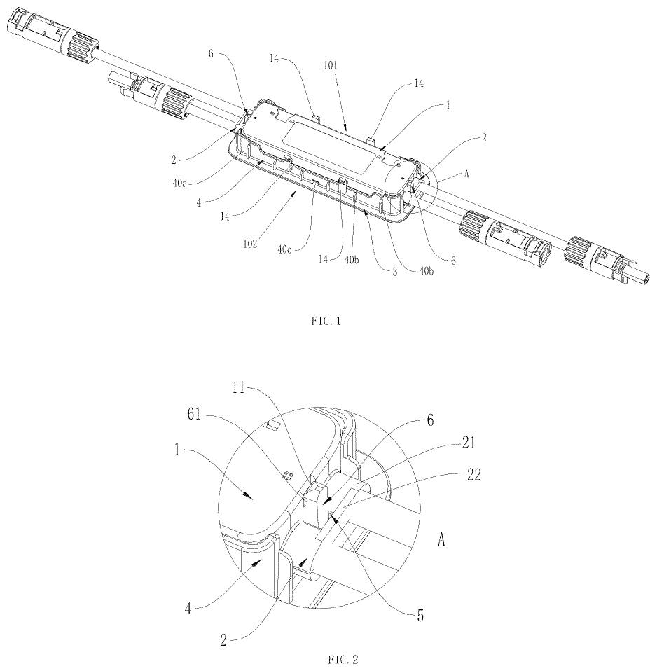

FIG. 1 is a schematic perspective structural view of a mounting and fixing system for photovoltaic junction box according to Embodiment 1 of the present disclosure;

FIG. 2 is an enlarged schematic view of part A in FIG. 1;

FIG. 3 is a partially exploded schematic view of FIG. 1;

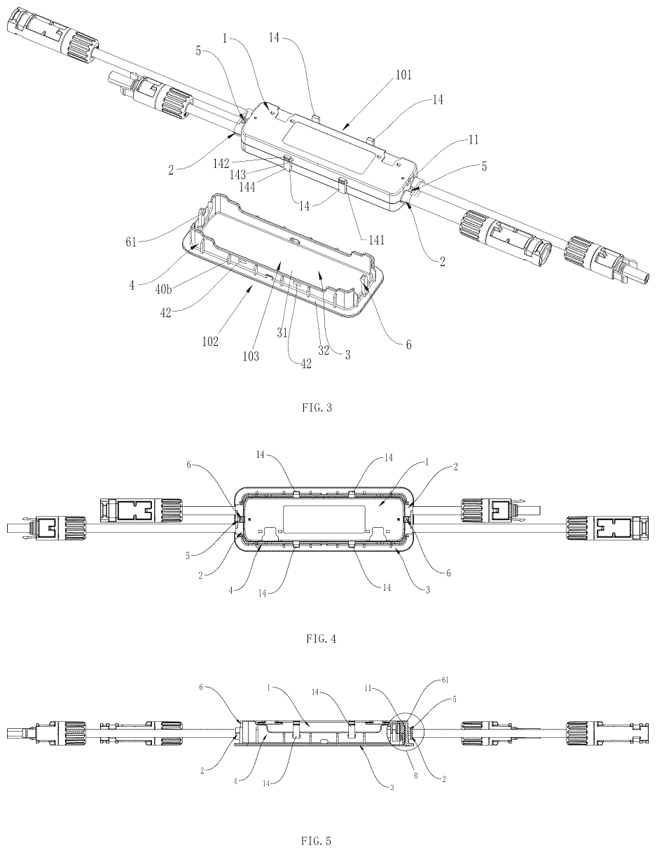

FIG. 4 is a top plan view of FIG. 1;

FIG. 5 is a front view of FIG. 1, wherein a cross-section is shown at part B;

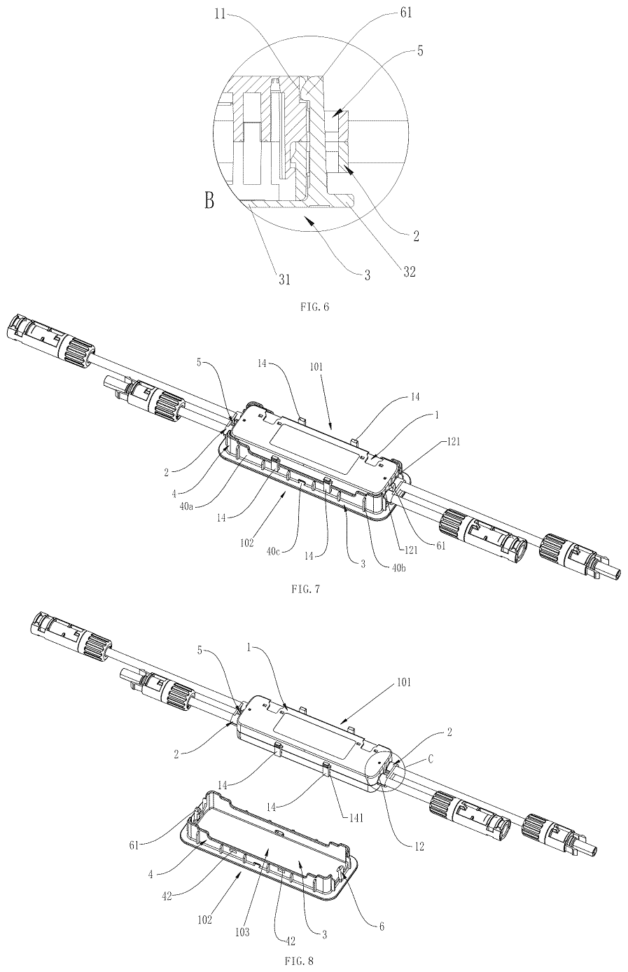

FIG. 6 is an enlarged schematic view of part B in FIG. 5;

FIG. 7 is a schematic perspective structural view of a mounting and fixing system according to Embodiment 2;

FIG. 8 is a partially exploded schematic view of FIG. 7;

FIG. 9 is an enlarged schematic view of part C in FIG. 8;

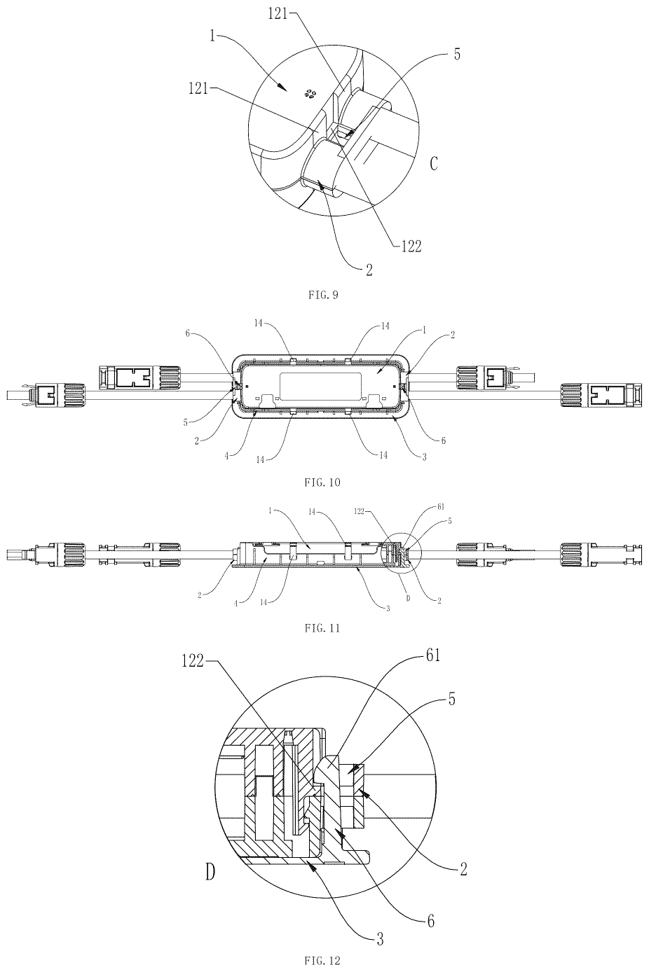

FIG. 10 is a top plan view of FIG. 7;

FIG. 11 is a front view of FIG. 7, wherein a cross-section is shown at part D;

FIG. 12 is an enlarged schematic view of part D in FIG. 11;

FIG. 13 is a schematic perspective structural view of a mounting and fixing system according to Embodiment 3;

FIG. 14 is an enlarged schematic view of part E in FIG. 13;

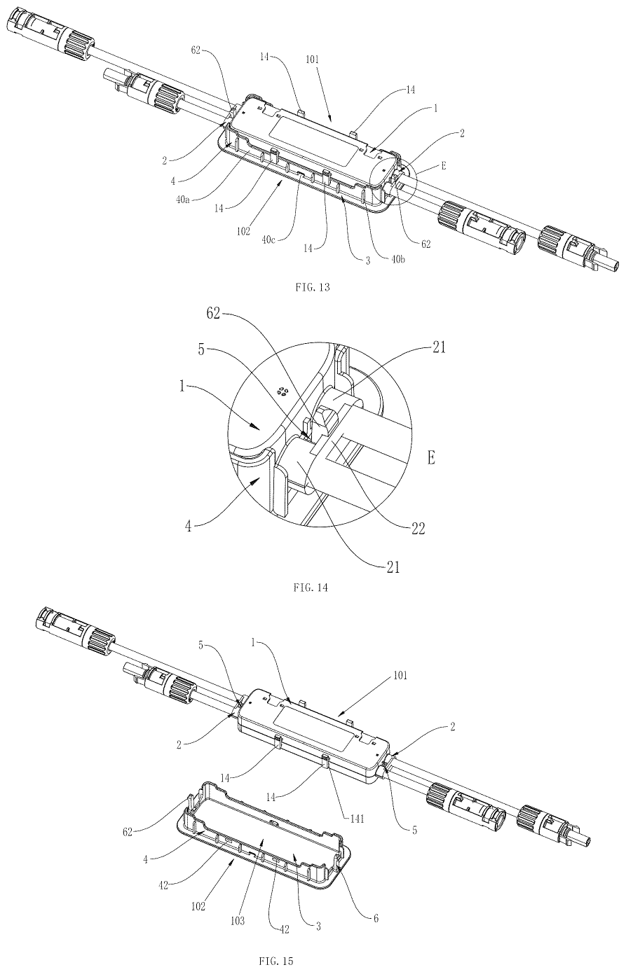

FIG. 15 is a partially exploded schematic view of FIG. 13;

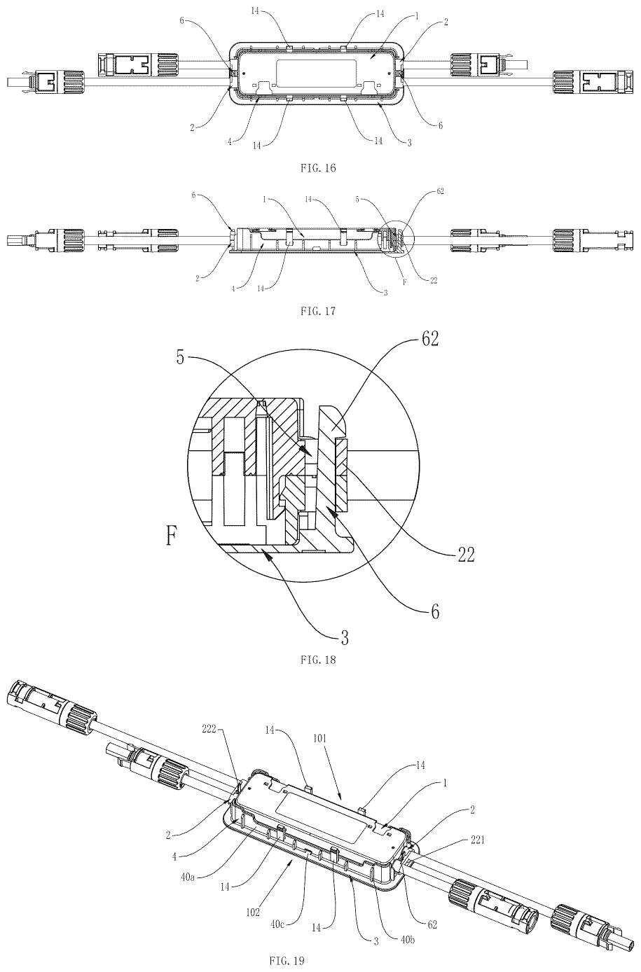

FIG. 16 is a top plan view of FIG. 13;

FIG. 17 is a front view of FIG. 13, wherein a cross-section is shown at part F;

FIG. 18 is an enlarged schematic view of part F in FIG. 17;

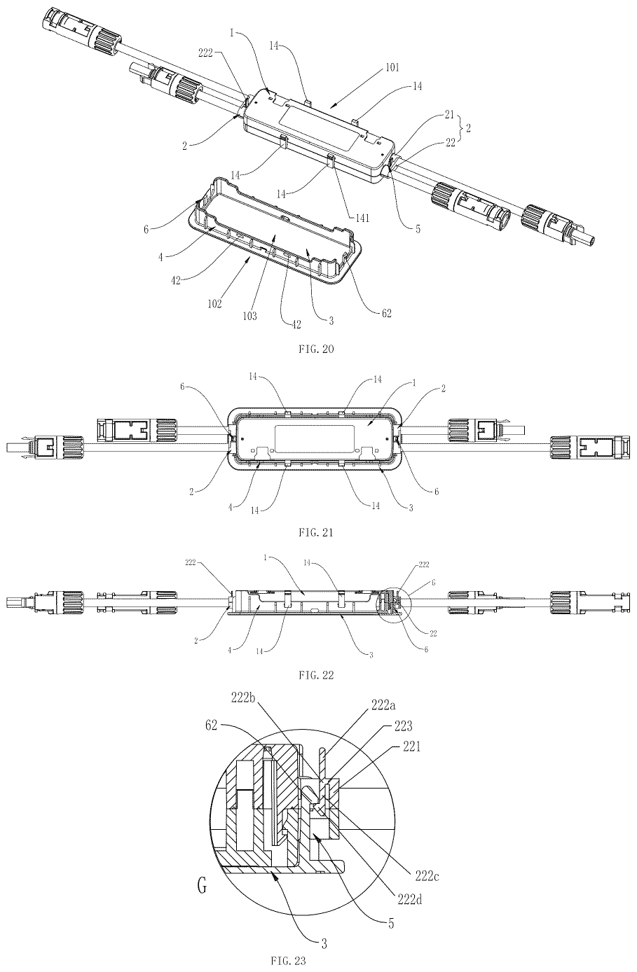

FIG. 19 is a schematic perspective structural view of a mounting and fixing system according to Embodiment 4;

FIG. 20 is a partially exploded schematic view of FIG. 19;

FIG. 21 is a top plan view of FIG. 19;

FIG. 22 is a front view of FIG. 19, wherein a cross-section is shown at part G;

FIG. 23 is an enlarged schematic view of part G in FIG. 22;

FIG. 24 is a partially exploded schematic view of a mounting and fixing system according to Embodiment 5;

FIG. 25 is a schematic view of FIG. 24 from another perspective;

FIG. 26 is a top plan view of FIG. 24;

FIG. 27 is a schematic cross-sectional view along line H-H in FIG. 26;

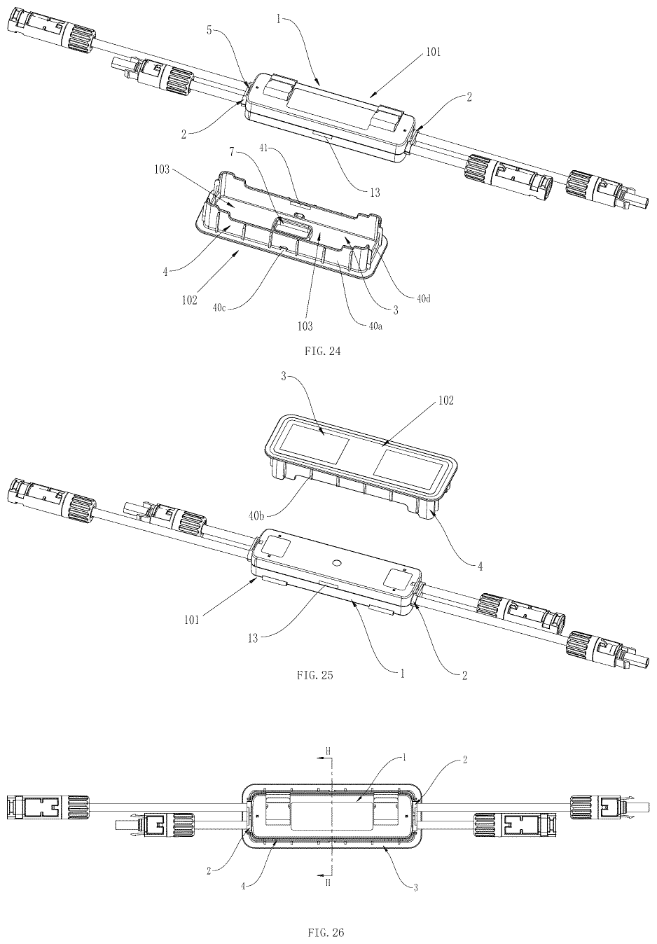

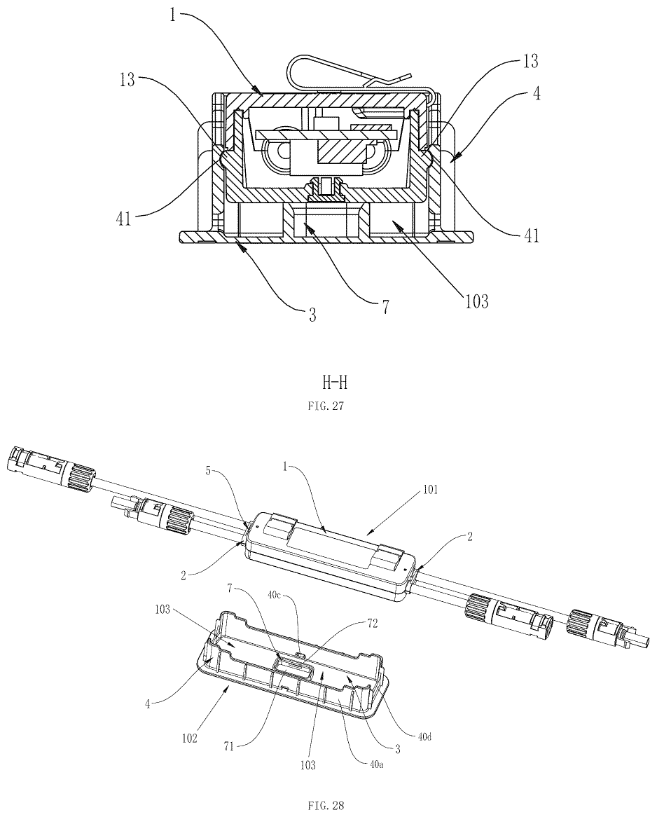

FIG. 28 is a partially exploded schematic view of a mounting and fixing system according to Embodiment 6;

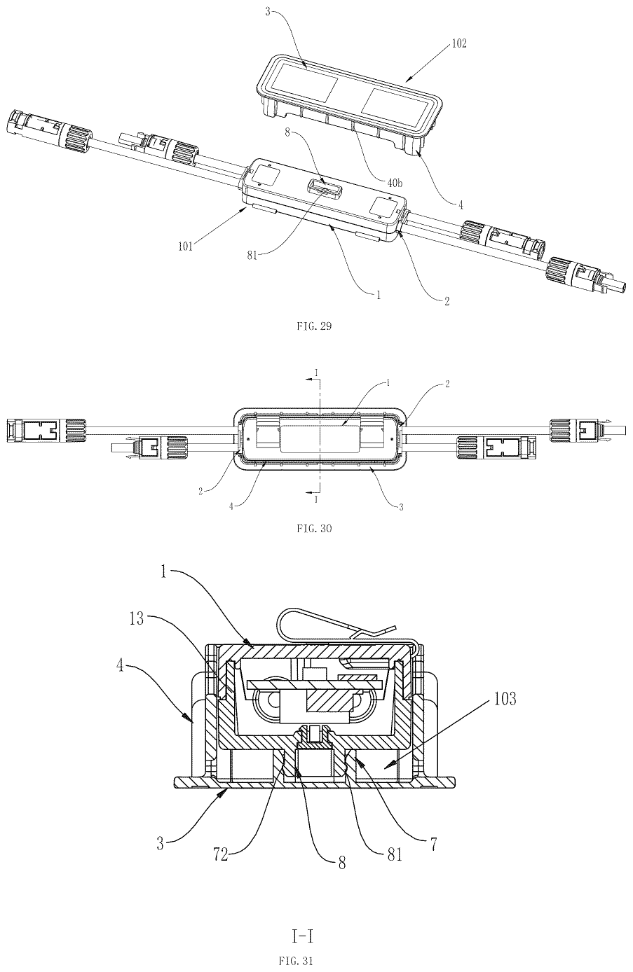

FIG. 29 is a schematic view of FIG. 28 from another perspective;

FIG. 30 is a top plan view of FIG. 28;

FIG. 31 is a schematic cross-sectional view along line I-I in FIG. 30;

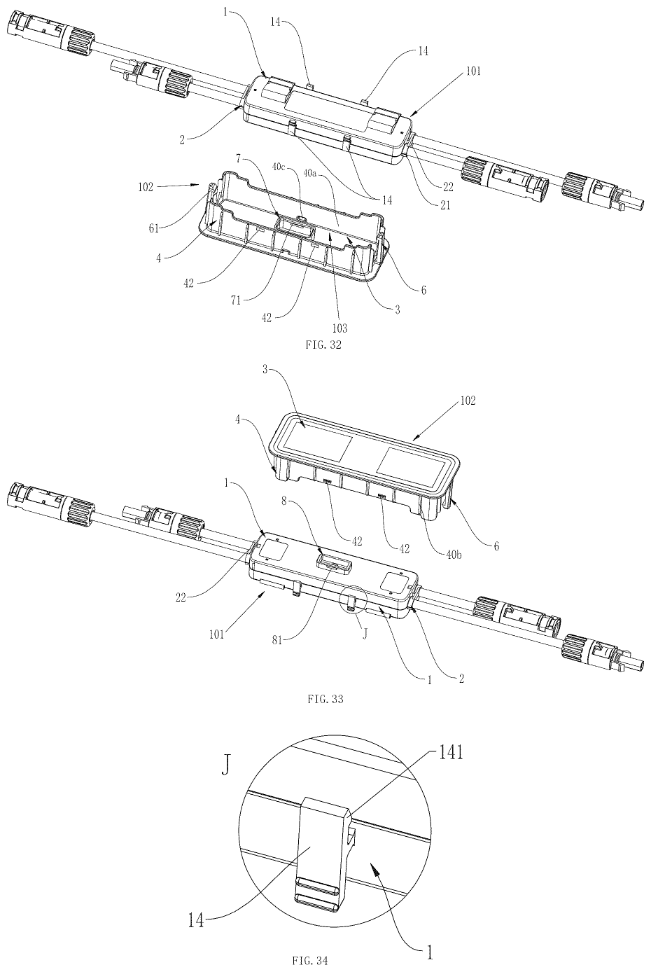

FIG. 32 is a partially exploded schematic view of a mounting and fixing system according to Embodiment 7;

FIG. 33 is a schematic view of FIG. 32 from another perspective;

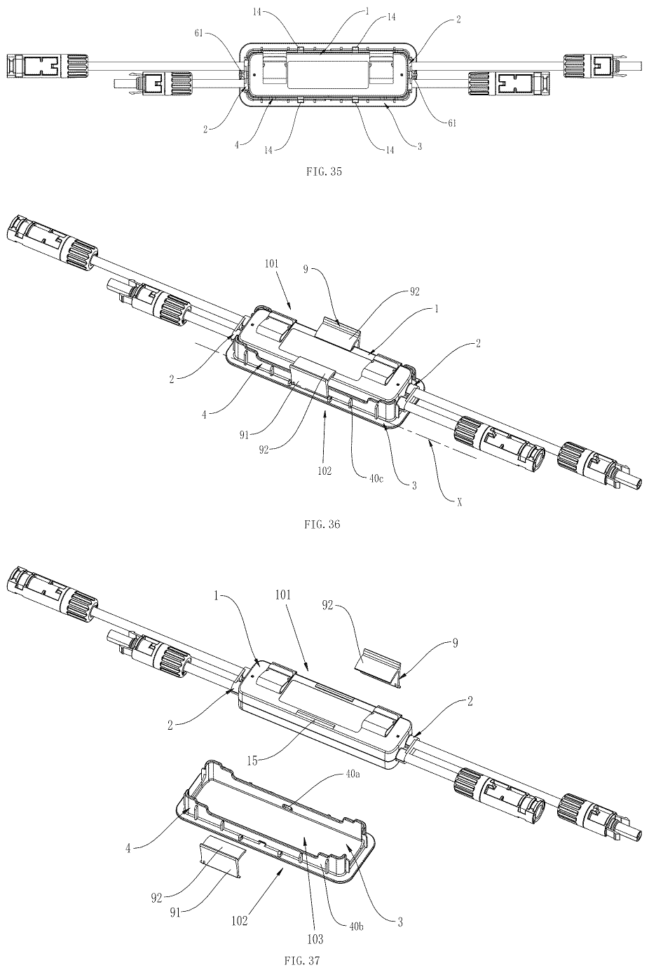

FIG. 34 is an enlarged schematic view of part J in FIG. 33;

FIG. 35 is a top plan view of FIG. 32;

FIG. 36 is a schematic perspective structural view of a mounting and fixing system according to Embodiment 8;

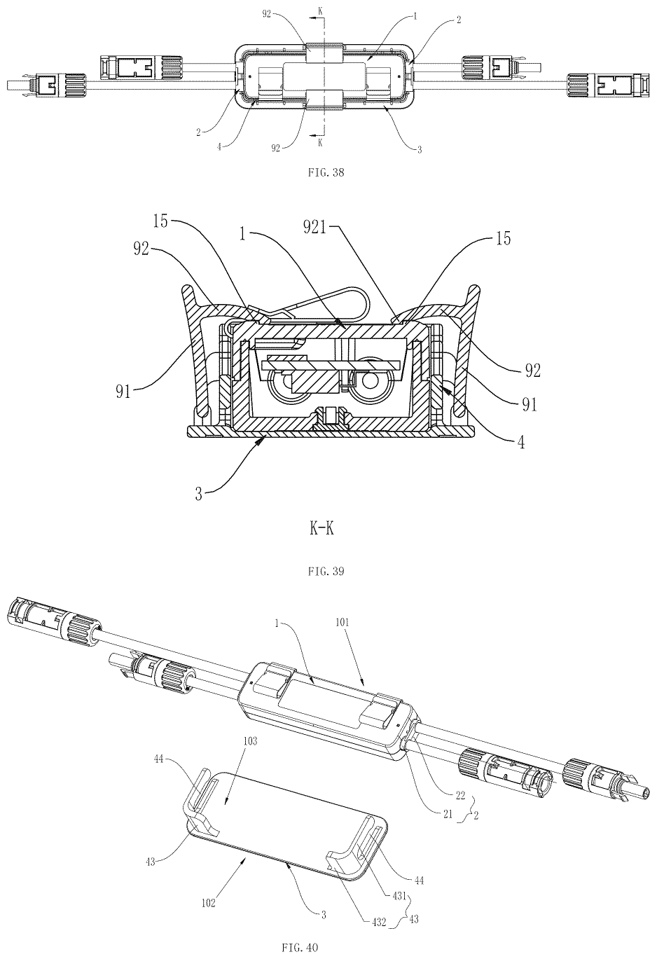

FIG. 37 is a partially exploded schematic view of FIG. 36;

FIG. 38 is a top plan view of FIG. 36;

FIG. 39 is a schematic cross-sectional view along line K-K in FIG. 38;

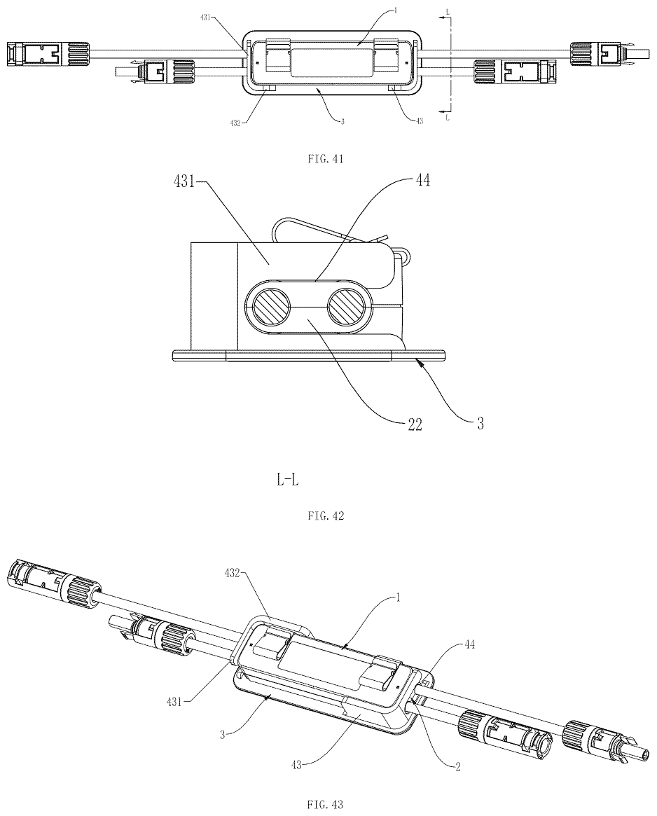

FIG. 40 is a partially exploded schematic view of a mounting and fixing system according to Embodiment 9;

FIG. 41 is a top plan view of FIG. 40;

FIG. 42 is a schematic cross-sectional view along line L-L in FIG. 41;

FIG. 43 is a schematic perspective structural view of a mounting and fixing system according to Embodiment 10;

FIG. 44 is a schematic view showing a method of connecting the photovoltaic junction box and the fixing base of the present embodiment;

FIG. 45 is a top plan view of FIG. 43;

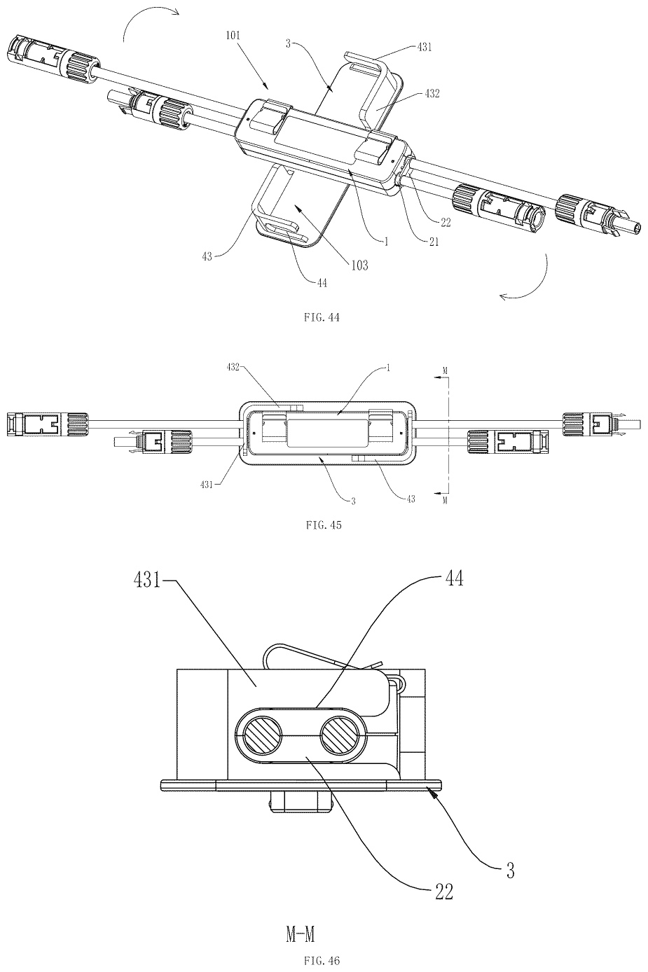

FIG. 46 is a schematic cross-sectional view along line M-M in FIG. 45;

FIG. 47 is a schematic structural view of fixing a photovoltaic junction box to a backsheet of a photovoltaic module using the mounting and fixing system of the present disclosure;

FIG. 48 is an overall schematic structural view of a fixing base in the mounting and fixing system of Embodiment 11;

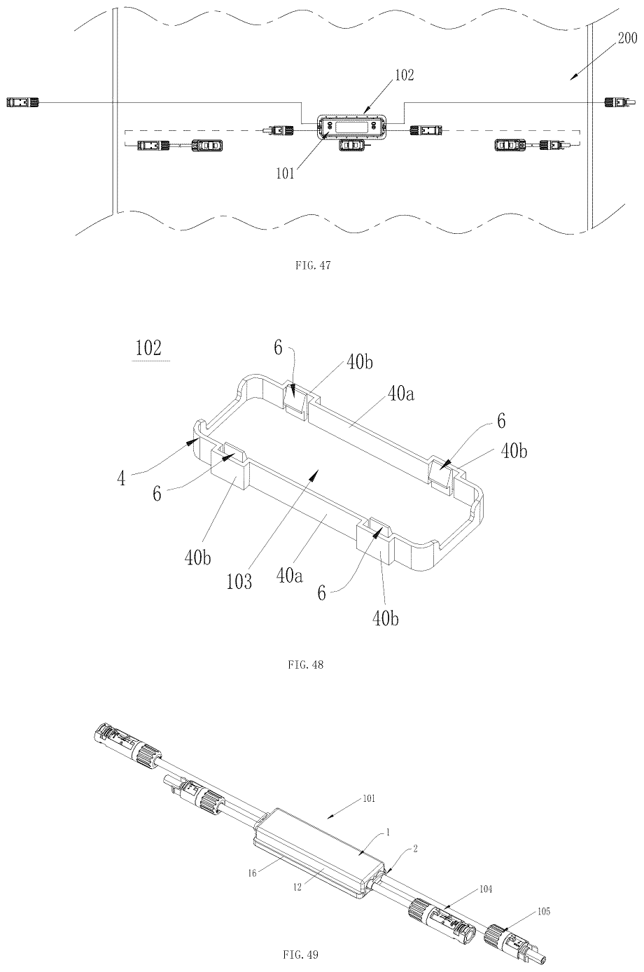

FIG. 49 is an overall schematic structural view of a photovoltaic junction box in the mounting and fixing system of Embodiment 11;

FIG. 50 is a schematic view of the mounting structure of the photovoltaic junction box and the fixing base in the mounting and fixing system of Embodiment 11;

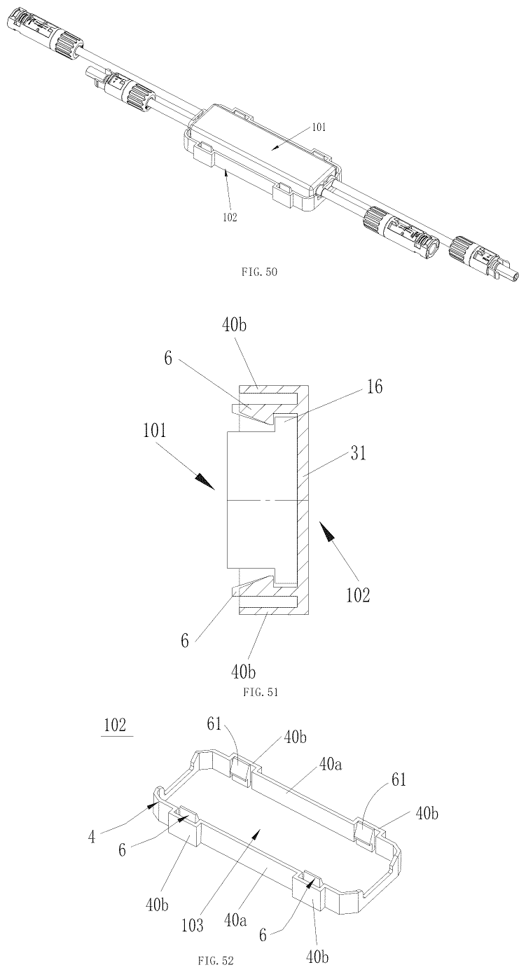

FIG. 51 is a schematic cross-sectional structural view of the mounting structure of the photovoltaic junction box and the fixing base in FIG. 50;

FIG. 52 is a schematic view of another structural form of the fixing base in the mounting and fixing system of Embodiment 11;

FIG. 53 is a schematic view of another structural form of the photovoltaic junction box in the mounting and fixing system of Embodiment 11;

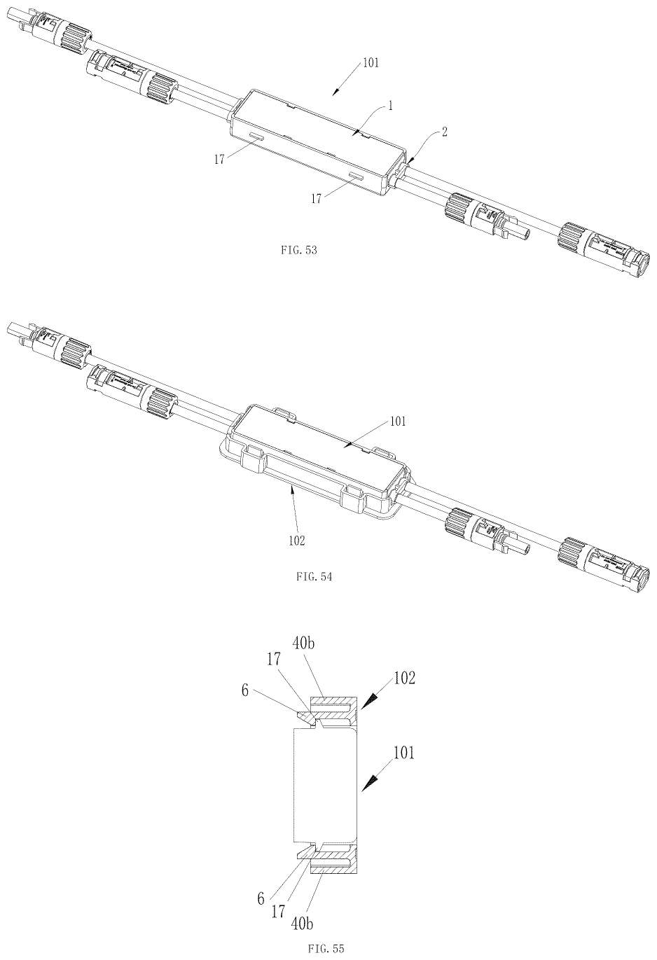

FIG. 54 is a schematic view of the mounting structure of the fixing base of FIG. 52 and the photovoltaic junction box of FIG. 53;

FIG. 55 is a schematic cross-sectional structural view of the mounting structure of the photovoltaic junction box and the fixing base in FIG. 54;

FIG. 56 is a schematic structural view of a first mounting method of the photovoltaic junction box and a photovoltaic module of Embodiment 11;

FIG. 57 is a schematic structural view of a second mounting method of the photovoltaic junction box and a photovoltaic module of Embodiment 11;

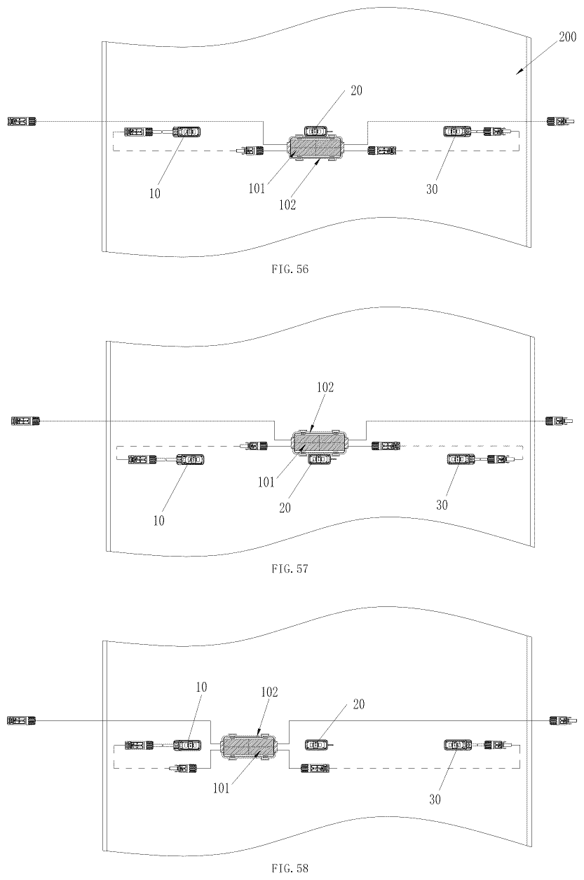

FIG. 58 is a schematic structural view of a third mounting method of the photovoltaic junction box and a photovoltaic module of Embodiment 11;

FIG. 59 is a schematic structural view of a fourth mounting method of the photovoltaic junction box and a photovoltaic module of Embodiment 11;

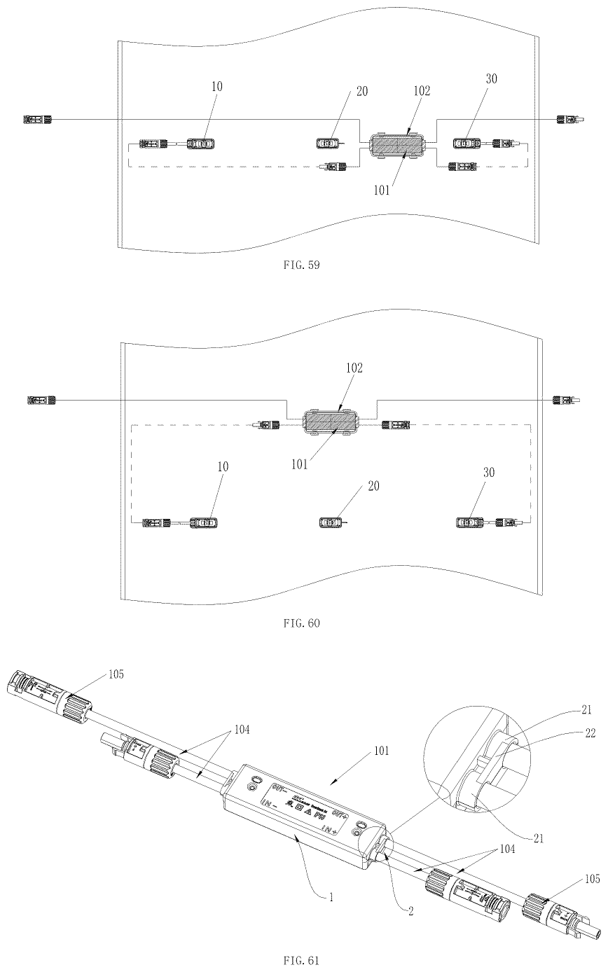

FIG. 60 is a schematic structural view of a fifth mounting method of the photovoltaic junction box and a photovoltaic module of Embodiment 11;

FIG. 61 is an overall schematic structural view of a photovoltaic junction box in the mounting and fixing system of Embodiment 12;

FIG. 62 is an overall schematic structural view of a fixing base in the mounting and fixing system of Embodiment 12;

FIG. 63 is a schematic view of the mounting structure of the photovoltaic junction box and the fixing base in the mounting and fixing system of Embodiment 12;

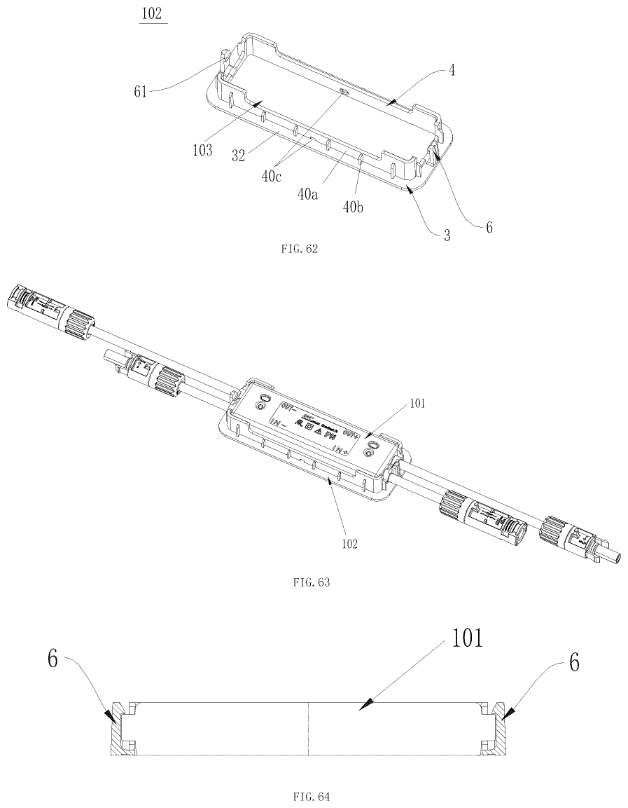

FIG. 64 is a schematic cross-sectional structural view of the mounting structure of the photovoltaic junction box and the fixing base in FIG. 63;

FIG. 65 is a schematic structural view of a first mounting method of the photovoltaic junction box and a photovoltaic module of Embodiment 12;

FIG. 66 is a schematic structural view of a second mounting method of the photovoltaic junction box and a photovoltaic module of Embodiment 12;

FIG. 67 is a schematic structural view of a third mounting method of the photovoltaic junction box and a photovoltaic module of Embodiment 12;

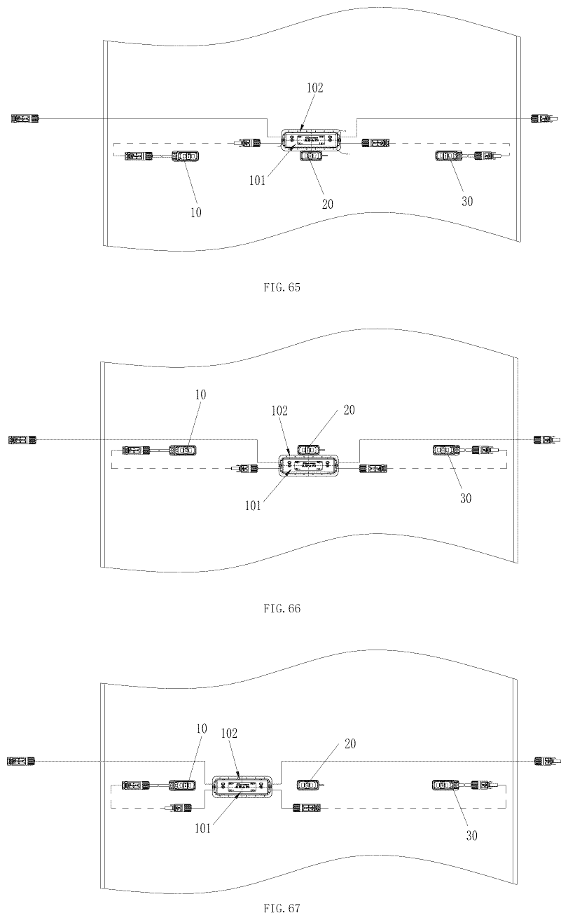

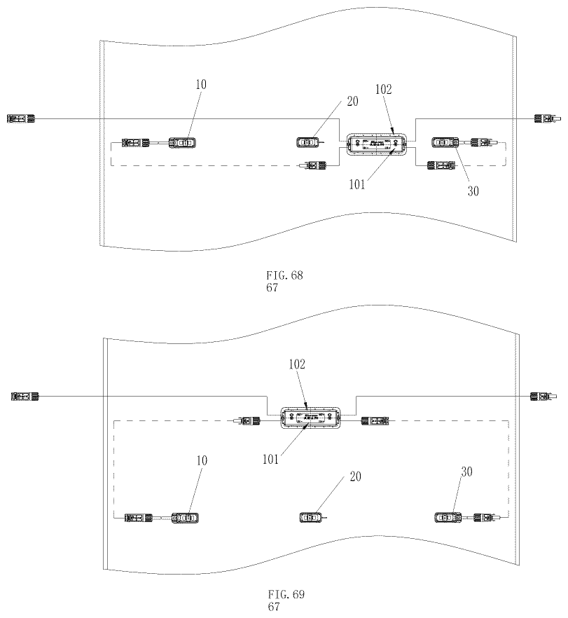

FIG. 68 is a schematic structural view of a fourth mounting method of the photovoltaic junction box and a photovoltaic module of Embodiment 12; and

FIG. 69 is a schematic structural view of a fifth mounting method of the photovoltaic junction box and a photovoltaic module of Embodiment 12;

Wherein: 101, photovoltaic junction box; 102, fixing base; 103, mounting space; 104, cable; 105, connector; 200, backsheet;
1, box main body; 11, first groove; 12, side wall; 121, side portion; 122, connecting rib; 13, first protrusion; 14, buckling member; 141, third protrusion; 15, limiting boss; 16, skirt structure; 17, wedge-shaped structure;
2, extension body; 21, extension part; 22, connecting part; 221, first connecting strip; 222, second connecting strip; 222a, operating part; 222b, fixing part; 222c, locking part; 222d, third hook; 223, third connecting strip;
3, bottom plate; 31, central plate body; 32, extension plate body;
4, side blocking assembly; 40a, baffle plate; 40b, reinforcing rib; 40c, drain port; 40d, support plate; 41, first recess; 42, third recess; 43, side block; 431, first side blocking part; 432, second side blocking part; 44, engaging slot; 45, hook stop plate;
5, through hole;
6, clasping member; 61, first hook; 62, second hook;
7, first connecting part; 71, insertion hole; 72, second recess;
8, second connecting part; 81, second protrusion;
9, latch; 91, mounting part; 92, latching part; 921, fourth hook;
10, left junction box; 20, middle junction box; 30, right junction box;
X, rotation centerline.

### DETAILED DESCRIPTION

The technical solutions in the embodiments of the present application will be described clearly and completely below in conjunction with the accompanying drawings, so that the advantages and features of the present disclosure can be more easily understood by those skilled in the art.

Obviously, the described embodiments are only a part of the embodiments of the present application, not all of them. Based on the embodiments in the present application, all other embodiments obtained by those skilled in the art without creative effort fall within the protection scope of the present application.

Referring to the mounting and fixing system for photovoltaic junction box as shown in the various figures, it comprises a photovoltaic junction box 101 and a fixing base 102. Wherein, the photovoltaic junction box 101 comprises a box body connectable to the fixing base 102, the box body comprises a box main body 1 with an accommodating cavity, and in some embodiments, the box body further comprises two extension bodies 2 separately provided at two ends of the box main body 1 and extending away from the box main body 1, wherein the extension bodies 2 are mainly used for cables to pass through to connect with components accommodated in the box main body 1. The fixing base 102 comprises a bottom plate 3, and a side blocking assembly 4 extending upward from the bottom plate 3. The side blocking assembly 4 and the bottom plate 3 enclose a mounting space 103, and the box main body 1 can be cooperatively accommodated in the mounting space 103. It should be noted that: 1. The statement that the box main body 1 is cooperatively accommodated in the mounting space 103 means that the box main body 1 is located within the mounting space 103 in the circumferential direction, not that all parts of the box main body 1 are located in the mounting space 103; 2. The side blocking assembly can be protruding ribs, protruding strips, side plates, etc., extending vertically upward from the bottom plate 3, and its size can be adjusted according to actual needs; 3. The statement that the side blocking assembly 4 and the bottom plate 3 enclose a mounting space 103 does not mean that the mounting space 103 must be located directly above the bottom plate 3, but rather that the height position where the bottom plate 3 is located defines the depth of the mounting space 103. A snap-fit structure is provided between the box body and the fixing base 102, and the box body and the fixing base 102 are interconnected by the snap-fit structure.

Through the independently provided fixing base 102, during the assembly and production of photovoltaic modules, during the construction of photovoltaic systems, or during the intelligent transformation of photovoltaic systems, as shown in FIG. 47, the fixing base 102 can be fixed to the backsheet 200 of a photovoltaic module, and then the photovoltaic junction box 101 is connected to the fixing base 102 through the snap-fit structure. This allows the photovoltaic junction box 101 to be simply and conveniently integrated into the photovoltaic power generation system, whether it is for the production of new smart modules or the intelligent transformation of conventional modules. The aforementioned snap-fit structure is a detachable structure, allowing the box body to be detached from the fixing base 102. In this way, when it is necessary to repair or replace the photovoltaic junction box 101, the photovoltaic junction box 101 can be directly removed from the fixing base 102, which is convenient for operator manipulation.

It should be noted that the above and following descriptions involving directions such as up, down, left, right, as well as front, back, inner, outer, etc., are all defined for reference based on the orientation observed by an operator when the fixing base 102 and the photovoltaic junction box 101 are fixed above a horizontally placed photovoltaic module backsheet 200. The purpose is only to clearly describe the relative positional relationships of the components in the mounting and fixing system for the photovoltaic junction box.

The technical solutions will be described in detail below in conjunction with specific embodiments.

### Embodiment 1

Referring to FIGS. 1 to 6, in this embodiment, the side blocking assembly 4 has an upward-facing upper opening, and the box main body 1 is inserted into the mounting space 103 through the upper opening when moving up and down relative to the fixing base 102. Specifically, when the position of the fixing base 102 is relatively fixed, moving the box main body 1 downward toward the fixing base 102 allows it to be inserted into the mounting space 103.

The box main body 1 has two oppositely arranged first side portions and two oppositely arranged second side portions, and the length of the first side portions is greater than the length of the second side portions. Here, the box main body 1 is substantially rectangular, and the extension direction of the first side portions is perpendicular to the extension direction of the second side portions, wherein the first side portion is the long side of the box main body 1, and the second side portion is the short side of the box main body 1.

In this embodiment, as shown in FIG. 1, the side blocking assembly 4 comprises two baffle plates 40a separately provided on different sides of the two first side portions. Here, the baffle plates 40a all extend vertically upward from the bottom plate 3. Here, the baffle plates 40a are configured such that their middle parts are recessed downward relative to their end parts, so that at least a part of the box main body 1 is exposed at this centrally recessed position, allowing an operator to conveniently remove the box body from the fixing base 102 when repairing the photovoltaic junction box 101. A plurality of reinforcing ribs 40b are also provided on the outer side of the baffle plates 40a to ensure the strength of the side blocking assembly 4. Drain ports 40c are provided at the lower part of the baffle plates 40a to drain accumulated water from the fixing base 102.

In this embodiment, the bottom plate 3 has a central plate body 31 located on the inner side of the side blocking assembly 4, and an extension plate body 32 extending outward from an outer wall of the side blocking assembly 3. The reinforcing ribs 40b are provided between the extension plate body 32 and the baffle plates 40a. The above structure of the bottom plate 3 also results in a larger bottom surface area for the fixing base 102, providing a larger attachment area when it is connected to the backsheet 200 of a photovoltaic module, thereby achieving better stability when it is adhered to the backsheet 200.

In this embodiment, as shown in FIGS. 2 and 6, a through hole 5 extending in the up-down direction is formed between the extension body 2 and the box main body 1. The snap-fit structure comprises two groups of clasping members 6 separately provided at both ends of the bottom plate 3 and extending in the up-down direction. The two groups of clasping members 6 can pass through the corresponding through holes 5 in the up-down direction and be snap-fitted with the box main body 1. Specifically, the extension body 2 comprises two extension parts 21 arranged in parallel and spaced apart, and a connecting part 22 provided between the two extension parts 21. One end of the extension part 21 is connected to a side wall of the box main body 1. The extension part 21 is hollow and is mainly for cables to pass through into the accommodating cavity of the box main body 1 to connect with components accommodated in the box main body 1. The aforementioned through hole 5 is formed between the two extension parts 21, the connecting part 22, and the box main body 1.

In this embodiment, the extension body 2 extends away from the box main body 1 from the second side portion. Two groups of clasping members 6 are separately provided on different sides of the two second side portions, and the two baffle plates 40a and the two groups of clasping members 6 are arranged around the periphery of the mounting space 103.

An upper portion of the clasping member 6 has a first hook 61. The first hooks 61 of the two groups of clasping members 6 are oppositely arranged. The box main body 1 is provided with a cooperating part that can be snap-fitted with the first hook 61. Referring to FIGS. 2 and 6, here, the cooperating part is a first groove 11 provided on a side wall of the box main body 1. When the box body and the fixing base 102 are connected together, the first hook 61 is inserted into the first groove 11 and abuts against a bottom wall of the first groove 11, so that the box main body 1 is pressed in the up-down direction between the bottom plate 3 and the clasping member 6, thereby being fixed to the fixing base 102.

Referring to FIG. 6, in this embodiment, an upper end portion of the clasping member 6 has a first inclined surface that extends obliquely into the mounting space 103 from top to bottom. When fixing and connecting the photovoltaic junction box 101 and the fixing base 102, the box main body 1 is inserted downward into the mounting space 103, and at the same time, the two groups of clasping members 6 are respectively passed through the two through holes 5. During this process, the first inclined surface of the clasping member 6 first cooperates and slides with the side wall of the second side portion, causing the clasping member 6 to elastically deform in a direction away from the mounting space 103, until the first hook 61 moves to the position of the first groove 11. At this time, under the action of the elastic force of the clasping member 6 itself, the first hook 61 moves inward and is inserted into the first groove 11, thereby realizing the connection between the box body and the fixing base 102.

In other embodiments, the clasping member 6 may also be provided on only one end of the bottom plate 3. On the end of the bottom plate 3 where the buckling member 6 is provided, there may be one group or more groups of the buckling member 6.

In this embodiment, the snap-fit structure further comprises a buckling member 14 having a snap-fitting part, and a buckling part that can be cooperatively snap-fitted with the snap-fitting part. One of the buckling member 14 and the buckling part is provided on the box main body 1, and the other is provided on the side blocking assembly 4. When the box main body 1 is accommodated in the mounting space 103, the buckling member 14 is located outside the mounting space 103 and is cooperatively snap-fitted with the buckling part.

In this embodiment, the snap-fit structure formed by the buckling member 14 and the buckling part is provided on the first side portion, and along the length extension direction of the first side portion, there is one group or two or more mutually spaced groups of the snap-fit structure. In this way, the box main body 1 is snap-fitted on both its first side portion and second side portion through the snap-fit structures, making the installation of the box main body 1 on the fixing base 102 more stable. In other embodiments, the snap-fit structure formed by the buckling member 14 and the buckling part may also be provided on the second side portion, as long as its cooperative position is offset from the cooperative position of the clasping member 6 and the first groove 11. In this embodiment, as shown in FIGS. 1 to 5, the buckling member 14 is provided on the box main body 1, and the buckling part is provided on the side blocking assembly 4. Specifically, the buckling member 14 is provided on the first side portion, the buckling part is provided on the baffle plate 40a on the outer side of the first side portion, and two spaced-apart buckling members 14 are provided on each first side portion. Correspondingly, the buckling parts on the corresponding side portion of the side blocking assembly 4 also comprise two spaced-apart parts. Referring to FIGS. 1 to 5, in this embodiment, the buckling member 14 extends in the up-down direction and comprises an operating section 142, a fixing section 143, and a locking section 144 connected in sequence in the up-down direction. The fixing section 143 is attached to the box main body 1, and both the operating section 142 and the locking section 144 are spaced apart from an outer wall of the box main body 1. The snap-fitting part is provided at a lower part of the locking section 144, and the operating section 142 is suspended above the box main body 1. By pressing the operating section 142, the locking section 144 can be driven, via the lever principle, to move the snap-fitting part away from the buckling part, causing them to disengage from each other, thereby releasing the connection between the box main body 1 and the fixing base 102, which is convenient and fast.

In this embodiment, the snap-fitting part is a third protrusion 141 extending toward the mounting space 103, and the buckling part is a third recess 42 opened on the side blocking assembly 4. When the box main body 1 is accommodated in the mounting space 103, the third protrusion 141 and the third recess 42 are cooperatively snap-fitted.

In other embodiments, the buckling member 14 can also be configured as follows: the buckling member 14 comprises a locking section 144, a fixing section 143, and an operating section 142 connected in sequence in the up-down direction. The fixing section 143 is attached to the side blocking assembly 4, and both the operating section 142 and the locking section 144 are spaced apart from an outer wall of the side blocking assembly 4. The snap-fitting part is provided at an upper part of the locking section 144, and a lower part of the operating section 142 is suspended below the side blocking assembly 4. By pressing the operating section 142, the locking section 144 can also be driven to move the snap-fitting part away from the buckling part, thereby releasing the connection between the box main body 1 and the fixing base 102.

### Embodiment 2

Referring to FIGS. 7 to 12, the connection method between the box body and the fixing base 102 in this embodiment is similar to that in Embodiment 1. The main difference from Embodiment 1 lies in the different configuration of the cooperating part on the box main body 1 that cooperates with the clasping member 6. Specifically: in this embodiment, the box main body 1 comprises two side walls 12 provided at two ends. The side wall 12 comprises two side portions 121 arranged in parallel and spaced apart, and a connecting rib 122 connected between the two side portions 121. The first hook 61 is inserted between the two side portions 121 and is clasped on the connecting rib 122. Specifically, referring to FIGS. 9 and 12, when the box body and the fixing base 102 are connected together, the clasping member 6 passes through the through hole 5, and the first hook 61 abuts against an upper side surface of the connecting rib 122.

### Embodiment 3

Referring to FIGS. 13 to 18, the main difference in the connection method between the box body and the fixing base 102 in this embodiment from that in Embodiment 1 is that: in this embodiment, the two groups of clasping members 6 are snap-fitted with the extension body 2. Specifically, when the clasping member 6 passes through the through hole 5, the clasping member 6 is snap-fitted with the connecting part 22.

Referring to FIGS. 14 and 18, the clasping member 6 has a second hook 62 at an upper portion. The second hooks 62 of the two groups of clasping members 6 are arranged facing away from each other. When the box body and the fixing base 102 are connected together, the second hook 62 abuts against an upper surface of the connecting part 22.

### Embodiment 4

Referring to FIGS. 19 to 23, the main difference in the connection method between the box body and the fixing base 102 in this embodiment from that in Embodiment 3 is that: in this embodiment, in the extension body 2, the connecting part 22 comprises a first connecting strip 221 connected between the two extension parts 21, a second connecting strip 222 extending in the up-down direction, and a third connecting strip 223 connected between the first connecting strip 221 and the second connecting strip 222. Wherein, the provision of the third connecting strip 223 is mainly to create a certain distance between the first connecting strip 221 and the second connecting strip 222, allowing the second connecting strip 222 to bend, so that at least one of its ends can have a certain displacement along the length extension direction of the extension body 2. The clasping member 6 is cooperatively snap-fitted with the second connecting strip 222.

In this embodiment, as shown in FIG. 23, the second connecting strip 222 has an operating part 222a, a fixing part 222b, and a locking part 222c connected in sequence in the up-down direction. Wherein, the fixing part 222b is connected to the third connecting strip 223, and the operating part 222a and the locking part 222c are respectively suspended on the upper and lower sides of the third connecting strip 223. The clasping member 6 can be cooperatively snap-fitted with the locking part 222c, and the operating part 222a can be used to drive the clasping member 6 to disengage from the locking part 222c. Specifically, by pressing the operating part 222a, the operating part 222a is driven to move toward the box main body 1. Using the lever principle with the fixing part 222b as the fulcrum, the locking part 222c will move in a direction away from the box main body 1, thereby releasing the snap-fit between the clasping member 6 and the locking part 222c. In this way, when it is necessary to repair and inspect the photovoltaic junction box 101, the connection between the box body and the fixing base 102 can be released conveniently and quickly.

In this embodiment, the second connecting strip 222 is located on a side of the first connecting strip 221 facing the through hole. A lower part of the second connecting strip 222 has a third hook 222d extending toward the through hole 5. When the clasping member 6 is snap-fitted with the connecting part, the second hook 62 and the third hook 222d are hooked and fixed to each other. Referring to FIG. 23, the third hook 222d is provided at a lower end of the locking part 222c.

Referring to FIG. 23, an upper part of the second hook 62 has a second inclined surface (not labeled in the figure), and a lower part of the third hook 222d has a third inclined surface (not labeled in the figure). Both the second inclined surface and the third inclined surface extend away from the box main body 1 from top to bottom. The second hook 62 also has a downward-facing abutting surface, and the third hook 222d also has an upward-facing supporting surface. The locking part 222c and the first connecting strip 221 are spaced apart. In the process of inserting the box main body 1 downward into the mounting space 103, the second inclined surface and the third inclined surface cooperate and slide, causing the second hook 62 to move toward the mounting space 103, and the third hook 222d to move toward the first connecting strip 221. When the box body and the fixing base 102 are connected together, the second hook 62 moves to a position above the third hook 222d, and the clasping member 6 and the second connecting strip 222 return to their original states under the action of elastic force, with the abutting surface and the supporting surface abutting against each other.

### Embodiment 5

Referring to FIGS. 24 to 27, the connection method between the box body and the fixing base 102 in this embodiment is different from that in Embodiments 1 to 4. Specifically: in this embodiment, the snap-fit structure is provided between the box main body 1 and the side blocking assembly 4.

Specifically, the snap-fit structure comprises a first protrusion 13 and a first recess 41 that are cooperatively snap-fitted. One of the first protrusion 13 and the first recess 41 is provided on an outer side wall of the box main body 1, and the other is provided on an inner side wall of the side blocking assembly 4. When the box main body 1 is accommodated in the mounting space 103, the first protrusion 13 and the first recess 41 are correspondingly engaged.

In this embodiment, a first protrusion 13 is provided on an outer wall of each first side portion. Specifically, the first protrusion 13 is a protruding strip extending along a length direction of the first side portion, and the first recess 41 is provided on the inner side wall of the side blocking assembly 4. Along the length direction of the first side portion, there can be one group or two or more spaced-apart groups of the first protrusion 13.

In this embodiment, the side blocking assembly 4 further comprises two support plates 40d separately provided on different sides of the two second side portions. The two baffle plates 40a and the two support plates 40d are connected end to end and arranged around the periphery of the mounting space 103. When the box main body 1 is accommodated in the mounting space 103, the support plates 40d support a lower part of the extension body 2, allowing the box body and the fixing base 102 to maintain better stability.

In this embodiment, the fixing base 102 further comprises a first connecting part 7 extending upward from the bottom plate 3 in a protruding manner. The first connecting part 7 is located within the mounting space 103, and there can be one or more first connecting parts 7. When the box main body 1 is accommodated in the mounting space 103, the first connecting part 7 supports a lower part of the box main body 1, allowing the box main body 1 and the mounting space 103 to cooperate better.

### Embodiment 6

Referring to FIGS. 28 to 31, the main difference between this embodiment and Embodiment 5 is that: in this embodiment, no snap-fit structure is provided between the box main body 1 and the side blocking assembly 4; instead, the snap-fit structure is provided between the box main body 1 and the first connecting part 7. Specifically, the snap-fit structure comprises a second connecting part 8 extending downward from a bottom of the box main body 1 in a protruding manner. An insertion hole 71 is opened on the first connecting part 7, and the second connecting part 8 is inserted into the insertion hole 71 and is snap-fitted with the first connecting part 7. In this embodiment, the first connecting part 7 is hollow and forms an upward-opening insertion hole 71. The second connecting part 8 is also hollow. An outer peripheral wall of the second connecting part 8 is provided with a second protrusion 81 extending outwardly, and an inner hole wall of the insertion hole 71 is provided with a second recess 72 recessed inwardly. When the second connecting part 8 is inserted into the insertion hole 71, the second protrusion 81 and the second recess 72 are cooperatively snap-fitted. Referring to FIG. 31, in this embodiment, a hole wall at an upper part of the insertion hole 71 extends obliquely inward from top to bottom, making the insertion hole 71 wide at the top and narrow at the bottom, which facilitates the insertion of the second connecting part 8. At the same time, the inclined hole wall also provides guidance for the downward insertion of the second connecting part 8. Of course, in a specific configuration, the second recess 72 can also be provided on the outer peripheral wall of the second connecting part 8, and the second protrusion 81 can be provided on the inner hole wall of the insertion hole. When the second connecting part 8 is inserted into the insertion hole 71, the snap-fit between the first connecting part 7 and the second connecting part 8 can also be achieved through the cooperation between the second protrusion 81 and the second recess 72. As an alternative to this embodiment, the second connecting part 8 can also be sleeved on the first connecting part 7 and snap-fitted with the first connecting part 7. A friction-increasing structure is provided on the cooperating side walls of the first connecting part 7 and the second connecting part 8. This friction-increasing structure can be in a form similar to the cooperation of the aforementioned second protrusion 81 and second recess 72, or it can be in other forms, such that the first connecting part 7 and the second connecting part 8 cooperate and do not easily disengage, thereby fixing them to each other to achieve a snap-fit and improving the stability of the connection between the box body and the fixing base 102. In a specific configuration, an insertion hole for inserting the first connecting part 7 can be opened on the second connecting part 8. On one of an inner hole wall of this insertion hole and an outer peripheral wall of the first connecting part, a radial protrusion extending outwardly is provided, and on the other, a radial recess recessed inwardly is provided. When the first connecting part 7 is inserted into the insertion hole of the second connecting part 8, the aforementioned radial protrusion and radial recess cooperate to achieve the snap-fit between the first connecting part 7 and the second connecting part 8.

### Embodiment 7

Referring to FIGS. 32 to 35, this embodiment is an improvement based on Embodiment 6. Specifically, on the basis of Embodiment 6, another group of snap-fit structures is provided between the box main body 1 and the side blocking assembly 4, making the connection between the box body and the fixing base 102 more stable and reliable.

This group of snap-fit structures comprises a buckling member 14 having a snap-fitting part, and a buckling part that can be cooperatively snap-fitted with the snap-fitting part. One of the buckling member 14 and the buckling part is provided on the box main body 1, and the other is provided on the side blocking assembly 4. When the box main body 1 is accommodated in the mounting space 103, the buckling member 14 is located outside the mounting space 103 and is cooperatively snap-fitted with the buckling part.

In this embodiment, the snap-fit structure formed by the buckling member 14 and the buckling part is provided on the first side portion, and along the length extension direction of the first side portion, there is one group or two or more mutually spaced groups of the snap-fit structure. In this way, the box main body 1 is snap-fitted on both its first side portion and second side portion through the snap-fit structures, making the installation of the box main body 1 on the fixing base 102 more stable. In other embodiments, the snap-fit structure formed by the buckling member 14 and the buckling part may also be provided on the second side portion.

In this embodiment, as shown in FIGS. 32 to 35, the buckling member 14 is provided on the box main body 1, and the buckling part is provided on the side blocking assembly 4. Specifically, the buckling member 14 is provided on the first side portion, the buckling part is provided on the baffle plate 40a on the outer side of the first side portion, and two spaced-apart buckling members 14 are provided on each first side portion. Correspondingly, the buckling parts on the corresponding side portion of the side blocking assembly 4 also comprise two spaced-apart parts. Referring to FIG. 34, in this embodiment, the buckling member 14 extends in the up-down direction. A middle portion of the buckling member 14 is attached to the box main body 1, and the buckling member 14 is spaced apart from an outer wall of the box main body 1. The snap-fitting part is provided at a lower part of the buckling member 14, and an upper part of the buckling member 14 is suspended above the box main body 1. By pressing the upper part of the buckling member 14, the snap-fitting part can be driven, via the lever principle, to move away from the buckling part, causing them to disengage from each other, thereby releasing the connection between the box main body 1 and the fixing base 102, which is convenient and fast. In this embodiment, the snap-fitting part is a third protrusion 141 extending toward the mounting space 103, and the buckling part is a third recess 42 opened on the side blocking assembly 4.

When the box main body 1 is accommodated in the mounting space 103, the third protrusion 141 and the third recess 42 are cooperatively snap-fitted.

### Embodiment 8

Referring to FIGS. 36 to 39, the connection method between the box body and the fixing base 102 in this embodiment is different from that in Embodiments 1 to 7. Specifically: in this embodiment, the snap-fit structure comprises a latch 9 movably provided on the fixing base 102. The latch 9 is located outside the mounting space 103. When the box main body 1 is accommodated in the mounting space 103, at least a part of the latch 9 can be buckled downward onto the box main body 1.

Referring to FIGS. 36 to 39, the latch 9 comprises a mounting part 91 extending in the up-down direction, and a latching part 92 extending from one side of the mounting part 91 toward the mounting space 103. The latching part 92 can be buckled downward onto an upper part of the box main body 1, so that the box main body 1 is restricted in the up-down direction between the latch 9 and the fixing base 102.

The latch 9 is rotatably connected to the fixing base 102. Referring to FIGS. 36 and 39, a lower part of the mounting part 91 is rotatably connected to the fixing base 102 about a rotation centerline X extending in a horizontal direction, and the latching part 92 is arc-shaped with the rotation centerline X as a rotation center axis.

There is more than one group of latches 9, in some embodiments there is two groups. Each group of latches 9 comprises one or more latches 9. The latching parts 92 of the two groups of latches 9 are oppositely arranged. When the box main body 1 is accommodated in the mounting space 103, the two groups of latches 9 can be buckled onto a pair of oppositely arranged side portions of the box main body 1. Here, when the box main body 1 is accommodated in the mounting space 103, the two groups of latches 9 can be respectively buckled onto the two first side portions.

In this embodiment, the latching part 92 is provided with a fourth hook 921, and an upper part of the box main body 1 is provided with a limiting boss 15. The fourth hook 921 can be cooperatively buckled onto the limiting boss 15 to prevent the latching part 92 from slipping off the upper part of the box main body 1.

Referring to FIG. 39, on the latch 9 of this embodiment, at least a part of the mounting part 91 extends above the latching part 92. Through the mounting part 91 extending above the latching part 92, an operator can complete the buckling operation more easily and with less effort. At the same time, this part of the mounting part 91 also makes it easier to release the buckle between the latch 9 and the box main body 1.

### Embodiment 9

Referring to FIGS. 40 to 42, the connection method between the box body and the fixing base 102 in this embodiment is different from that in Embodiments 1 to 8. Specifically: in this embodiment, the box main body 1 achieves cooperation with the mounting space 103 when moving in a horizontal direction relative to the fixing base 102. The snap-fit structure is provided between the side blocking assembly 4 and the box body. When the box main body 1 moves in the horizontal direction relative to the fixing base 102, the box body and the fixing base 102 can be fixed to each other through the cooperation of the snap-fit structure therebetween.

Specifically, the side blocking assembly 4 has an engaging slot 44. The engaging slot 44 has a side opening facing one side in the horizontal direction of the fixing base 102, and the extension body 2 can be cooperatively engaged in the engaging slot 44.

In this embodiment, the side blocking assembly 4 comprises two spaced-apart side blocks 43. Each of the side blocks 43 is provided with an engaging slot 44. When the box main body 1 is located in the mounting space 103, the two extension bodies 2 are correspondingly engaged in the two engaging slots 44. Specifically, the extension body 2 comprises an extension part 21 and a connecting part 22 provided on the extension part 21. One end of the extension part 21 is connected to a side wall of the box main body 1 and extends outward away from the box main body 1. An extension direction of the connecting part 22 is perpendicular to an extension direction of the extension part 21. When the engaging slot 44 is snap-fitted with the extension body 2, the side blocking assembly 4 is engaged on the extension part 21 and is located between the box main body 1 and the connecting part 22.

Referring to FIG. 40, in this embodiment, the side openings of the two engaging slots 44 face the same side of the fixing base 102. The box main body 1 achieves cooperation with the mounting space 103 in the process of translating horizontally relative to the fixing base 102, and in the process of translation, the extension body 2 can be driven to engage into the engaging slot 44. In this embodiment, as shown in FIG. 40, the side block 43 at least comprises a first side blocking part 431 provided with the engaging slot 44. The first side blocking parts 431 of the two side blocks 43 are separately provided on different sides of the two second side portions, that is, along the length extension direction of the first side portion, the box main body 1 is located between the two first side blocking parts 431.

In this embodiment, each of the side blocks 43 further comprises a second side blocking part 432 connected to the first side blocking part 431. The first side blocking part 431 and the second side blocking part 432 form an L-shape, wherein the second side blocking parts 432 of the two side blocks 43 are both located on the same side of one of the first side portions. In some embodiments, the two second side blocking parts 432 can extend toward each other and be connected together, so that the two side blocks 43 together form a U-shape. When the box main body 1 is located in the mounting space 103, one first side portion of the box main body 1 abuts against the second side blocking part 432, improving the stability of the connection between the box body and the fixing base 102.

During installation, the box body is moved horizontally toward the fixing base 102, so that the two extension bodies 2 are correspondingly inserted into the two engaging slots 44, thereby achieving the fixed installation of the box body on the fixing base 102. The installation is also very convenient.

### Embodiment 10

Referring to FIGS. 43 to 46, the main difference between this embodiment and Embodiment 9 is that: in this embodiment, the side openings of the two engaging slots 44 face opposite directions, and the box main body 1 achieves cooperation with the mounting space 103 in the process of rotating horizontally relative to the fixing base 102.

Specifically in this embodiment, each of the side blocks 43 also comprises a second side blocking part 432 connected to the first side blocking part 431, and the first side blocking part 431 and the second side blocking part 432 form an L-shape. However, in this embodiment, the second side blocking parts 432 of the two side blocks 43 are separately provided on different sides of the two first side portions, and a sum of lengths of the two second side blocking parts 432 is less than a length of the first side portion.

Referring to FIG. 44, when connecting the photovoltaic junction box 101 and the fixing base 102, the box main body 1 is first inserted between the two second side blocking parts 432, and then the box main body 1 is rotated so that the two extension bodies 2 at the two ends are correspondingly engaged into the two engaging slots 44. When the box main body 1 is located in the mounting space 103, the two first side portions of the box main body 1 respectively abut against the two second side blocking parts 432, improving the stability of the connection.

### Embodiment 11

Referring to FIGS. 48 to 55, the mounting and fixing system for photovoltaic junction box of this embodiment is similar to Embodiment 1. One or more groups of clasping members 6 extending in the up-down direction are also provided on the fixing base 102. The clasping members 6 are respectively snap-fitted with the box main body 1. The clasping members 6 are provided on one end of the bottom plate 3 or are separately provided on both ends of the bottom plate 3, and an upper portion of each clasping member 6 has a first hook 61. The box main body 1 is provided with a cooperating part that can be snap-fitted with the first hook 61.

However, unlike Embodiment 1, in this embodiment, the box main body 1 comprises two side walls 12 provided at two ends. The cooperating part is a skirt structure 16 provided on the side wall 12 and extending outwardly in a protruding manner, as shown in FIGS. 48 to 51. The cooperating part can also be a wedge-shaped structure 17 provided on an outer wall of the side wall 12 and protruding outwardly, as shown in FIGS. 52 to 55. Alternatively, the cooperating part can also be a clasping hole provided on an outer side of the side wall 12 and recessed inwardly.

More specifically, in the rapid mounting and fixing system of this embodiment, the smart photovoltaic junction box 101 comprises a box body. A side of the box body is provided with an engaging structure for cooperating with the clasping member 6. Two ends of the box body are connected with at least one group of connectors 105 via cables 104. The fixing base 102 comprises a main body with an open top. The main body is provided with a cavity for accommodating the box body of the smart photovoltaic junction box 101. Its side is provided with a plurality of hooks for buckling with the engaging structure of the smart photovoltaic junction box 101. Here, the cavity is the aforementioned mounting space 103, and the hooks are the clasping members 6 having the first hook 61. The engaging structure of the smart photovoltaic junction box 101 is the skirt structure 16 or the wedge-shaped structure 17 or the clasping hole provided on the box main body 1 as described above.

In this embodiment, the cooperating part is provided on the first side portion of the box main body 1, and cooperating parts are provided on both first side portions, that is, cooperating parts are provided on both long sides of the box main body 1. One or more groups of clasping members 6 are also provided on the two corresponding ends of the fixing base 102. When the cooperating part is the skirt structure 16 as shown in FIG. 49, the skirt structure 16 extends along the length direction of the box main body 1 and has the same length as the first side portion. When the cooperating part is the wedge-shaped structure 17 as shown in FIG. 53 or a clasping hole, its number is consistent with the number of groups of clasping members 6, and their positions correspond.

In the embodiment shown in FIGS. 48 to 51, the fixing base 102 is a box-shaped structure with an open top. A bottom surface of the fixing base 102 is fixed to the backsheet 200 of a photovoltaic module by adhesive. Here, the bottom plate 3 only has the central plate body 31 located on the inner side of the side blocking assembly 4, and it is the bottom surface of this central plate body 31 that is adhesively fixed to the backsheet 200. In the embodiment shown in FIGS. 52 to 55, the fixing base 102 can also be designed as a frame-shaped structure. At this time, to facilitate fixing the bottom surface of the fixing base 102 to the backsheet 200 by adhesive, a protruding edge structure extends outward at the bottom of the frame. When fixing to the backsheet 200, adhesive is applied to the bottom of the protruding edge structure and then fixed to the backsheet 200. Moreover, the frame structure can reduce the height of the fixing base 102 and also save material. That is, here the bottom plate 3 only has the extension plate body 32 located on the outer side of the side blocking assembly 4, and it is the bottom surface of this extension plate body 32 that is adhesively fixed to the backsheet 200. It should be understood that the fixing base 102 of this embodiment can also be designed as a box-shaped structure with an open top, with the bottom surface of the fixing base 102 fixed to the backsheet 200 by adhesive.

An outer side of the clasping member 6 is also provided with a hook stop plate 40b. The hook stop plate 40b extends upward from the bottom plate 3, and the hook stop plate 40b is spaced apart from the clasping member 6. The hook stop plate 40b is used to limit the movement distance of the first hook 61 during the assembly and disassembly of the smart junction box, preventing the hook from breaking and failing due to excessive bending. In this embodiment, the hook stop plate 40b and the side blocking assembly 4 are integrally formed, and the side blocking assembly 4 and the hook stop plate 40b enclose a frame-shaped structure that is closed in a circumferential direction.

In some embodiments, the fixing base 102 is an independent component, fixed to the backsheet 200 of a photovoltaic module by adhesive. It can be pre-installed on the backsheet 200 during module production, or it can be fixed to the backsheet 200 during the intelligent transformation of a photovoltaic system construction. In embodiments, the fixing base 102 and the box body of a conventional junction box are designed as a single piece, and are pre-fixed and installed on the backsheet 200 of a photovoltaic module by adhesive.

When installing a smart photovoltaic junction box 101 and a photovoltaic module according to the aforementioned rapid mounting and fixing system for a smart photovoltaic junction box, a conventional junction box is installed on the back of the photovoltaic module. Referring to FIG. 56, in some embodiments, the conventional junction box is a three-part split junction box, comprising a left junction box 10, a middle junction box 20, and a right junction box 30. The smart photovoltaic junction box 101 is installed above the middle junction box 20 of the split junction box, and one group of connectors of the smart photovoltaic junction box 101 are respectively plugged into a connector connected to the left junction box 10 and a connector connected to the right junction box 30. In some embodiments, the fixing base 102 and the box body of the middle junction box 20 are designed as a single piece, or it can be an independent fixing base, pre-fixed and installed on the photovoltaic module backsheet 200 by adhesive.

Referring to FIG. 57, in another embodiment, the smart photovoltaic junction box 101 is installed below the middle junction box 20 of the split junction box. One group of connectors of the smart photovoltaic junction box can be respectively plugged into a connector connected to the left junction box 10 and a connector connected to the right junction box 30.

In FIGS. 56 and 57, the smart photovoltaic junction box 101 is installed above or below the middle junction box 20 of the split junction box. It should be understood that it can also be installed above or below the left junction box 10 or the right junction box 20. At this time, the fixing base 102 and the split junction box can be installed adjacent to each other at a certain distance, or can be installed in close proximity to the split junction box.

Referring to FIG. 58, in another embodiment, the smart photovoltaic junction box 101 is installed between the left junction box 10 and the middle junction box 20 of the split junction box, and one group of connectors of the smart photovoltaic junction box are respectively plugged into a connector connected to the left junction box 10 and a connector connected to the right junction box 30.

Referring to FIG. 59, in another embodiment, the smart photovoltaic junction box 101 is installed between the middle junction box 20 and the right junction box 30 of the split junction box, and one group of connectors of the smart photovoltaic junction box are respectively plugged into a connector connected to the left junction box 10 and a connector connected to the right junction box 30.

Referring to FIG. 60, in another embodiment, while taking into account factors such as the overall layout of the module, installation requirements, and installation costs, the smart photovoltaic junction box 101 can be flexibly installed at any position on the back of the module according to specific installation needs. One group of connectors of the smart photovoltaic junction box are respectively plugged into a connector connected to the left junction box 10 and a connector connected to the right junction box 30.

### Embodiment 12

Referring to FIGS. 61 to 64, this embodiment is similar to Embodiment 2, where the clasping member 6 is snap-fitted with the extension body 2 of the box body. The main difference between the two is that, in this embodiment, the clasping member 6 and the box main body 1 are provided on different sides of the extension body 2, that is, the clasping member 6 is provided on the outer side of the photovoltaic junction box 101, and the extension direction of the first hook 61 of the clasping member 6 is toward the mounting space 103.

More specifically, referring to FIG. 61, the smart photovoltaic junction box comprises a box body, which is the photovoltaic junction box 101. Two ends of the photovoltaic junction box 101 are connected with at least one group of connectors 105 via cables 104. Referring to FIG. 62, in the mounting and fixing system of this embodiment, the fixing base 102 comprises a fixing base main body with a frame-shaped structure. A protruding edge structure for adhesive fixing to the photovoltaic module backsheet 200 is provided extending outward from the bottom of the fixing base main body. One opposite side of the fixing base main body is provided with hooks for buckling with the box body of the smart photovoltaic junction box, and the other opposite side is provided with a recessed structure, which can facilitate the removal of the smart photovoltaic junction box from the fixing base 102 during maintenance. The aforementioned fixing base main body is the side blocking assembly 4, the protruding edge structure is the extension plate body 32 of the bottom plate 3, and the hook is the clasping member 6. The clasping member 6 extends upward from the extension plate body 32, is located entirely on the outer side of the side blocking assembly 4, and its first hook 61 extends toward the mounting space 103. When the photovoltaic junction box 101 is inserted into the mounting space 103, the positions of the two clasping members 6 correspond to the positions of the two extension bodies 2, specifically corresponding and snap-fitting with the connecting part 22 of the extension body 2. Referring to FIG. 62, an outer side of the side blocking assembly 4 is provided with a plurality of reinforcing ribs 40b to ensure the structural strength of the fixing base 102. A bottom side of the side blocking assembly 4 is provided with a through drain port 40c, which can conveniently drain accumulated water from inside the fixing base 102. In some embodiments, the drain ports 40c are provided on two opposite side portions of the fixing base 102.

In this embodiment, the fixing base 102 is designed as a frame-shaped structure, and the extension plate body 32 is also frame-shaped and forms a protruding edge structure on the outer periphery of the side blocking assembly 4. When fixing to the photovoltaic module, adhesive is applied to the bottom of the extension plate body 32 and then fixed to the backsheet 200. This design of the frame structure can make the height of the fixing base 102 smaller and also save material. It should be understood that the fixing base 102 of this embodiment can also be designed as a box-shaped structure with an open top, with the bottom surface of the fixing base 102 fixed to the backsheet 200 by adhesive.

The mounting and fixing system for the smart photovoltaic junction box adopts an independently provided fixing base 102, which is fixed to the module backsheet 200 by adhesive. It can be pre-installed on the module backsheet 200 during photovoltaic module production, or fixed to the module backsheet 200 during photovoltaic system construction or intelligent transformation. Then, the smart photovoltaic junction box is installed in the fixing base 102. Whether for new smart modules or for the intelligent transformation of conventional modules, the smart photovoltaic junction box 101 can be conveniently integrated into the photovoltaic power generation system, improving the system's power generation efficiency, safety, etc.

When installing a smart photovoltaic junction box 101 and a photovoltaic module according to the aforementioned rapid mounting and fixing system for a smart photovoltaic junction box, a conventional junction box is installed on the back of the photovoltaic module. Referring to FIG. 65, in some embodiments, the conventional junction box is a three-part split junction box, comprising a left junction box 10, a middle junction box 20, and a right junction box 30. The smart photovoltaic junction box 101 is installed above the middle junction box 20 of the split junction box, and one group of connectors of the smart photovoltaic junction box 101 are respectively plugged into a connector connected to the left junction box 10 and a connector connected to the right junction box 30.

Referring to FIG. 66, in another embodiment, the smart photovoltaic junction box 101 is installed below the middle junction box 20 of the split junction box, and one group of connectors of the smart photovoltaic junction box are respectively plugged into a connector connected to the left junction box 10 and a connector connected to the right junction box 30.

In FIGS. 65 and 66, the smart photovoltaic junction box 101 is installed above or below the middle junction box 20 of the split junction box. It should be understood that it can also be installed above or below the left junction box 10 or the right junction box 20. At this time, the fixing base 102 and the split junction box can be installed adjacent to each other at a certain distance, or can be installed in close proximity to the split junction box.

Referring to FIG. 67, in another embodiment, the smart photovoltaic junction box 101 is installed between the left junction box 10 and the middle junction box 20 of the split junction box, and one group of connectors of the smart photovoltaic junction box are respectively plugged into a connector connected to the left junction box 10 and a connector connected to the right junction box 30.

Referring to FIG. 68, in another embodiment, the smart photovoltaic junction box 101 is installed between the middle junction box 20 and the right junction box 30 of the split junction box, and one group of connectors of the smart photovoltaic junction box are respectively plugged into a connector connected to the left junction box 10 and a connector connected to the right junction box 30.

Referring to FIG. 69, in another embodiment, while taking into account factors such as the overall layout of the module, installation requirements, and installation costs, the smart photovoltaic junction box 101 can be flexibly installed at any position on the back of the module according to specific installation needs. One group of connectors of the smart photovoltaic junction box are respectively plugged into a connector connected to the left junction box 10 and a connector connected to the right junction box 30.

In summary, in all the above embodiments, when connecting the photovoltaic junction box 101 to a photovoltaic module, the fixing base 102 can first be installed on the backsheet 200 of the photovoltaic module, and then the photovoltaic junction box 101 is connected to the fixing base 102 using a snap-fit structure, so that the mounting and fixing system can adapt to different installation scenarios. When it is necessary to repair or replace the photovoltaic junction box 101, an operator can conveniently and quickly remove the photovoltaic junction box 101 from the fixing base 102 by releasing the connection of the snap-fit structure.

The aforementioned photovoltaic junction box 101 can be a junction box with different functions, such as a module optimizer (MPPT), a shutdown junction box for photovoltaic use, a smart monitoring junction box for photovoltaic use, a microinverter for photovoltaic use, etc. By adopting this mounting and fixing system for photovoltaic junction box, it is possible to ship smart junction boxes pre-installed on modules, achieving differentiation and aesthetic appeal between modules. The fixing base 102 can be pre-adhered to the backsheet 200. When a smart photovoltaic junction box 101 is installed, it becomes a smart module; when it is not installed, it is a conventional module, which facilitates the intelligent transformation of conventional modules. Compared to designs where the smart junction box is directly adhered to the module, the fixing base-style design allows for replacement and maintenance when the smart junction box fails, saving on operation and maintenance costs.

Although the present invention has been disclosed in the form of embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A mounting and fixing system for photovoltaic junction box, comprising:
a fixing base and a photovoltaic junction box, the photovoltaic junction box comprises a box body connectable to the fixing base, wherein the box body comprises a box main body having an accommodating cavity, the fixing base comprises a bottom plate, and a side blocking assembly extending upward from the bottom plate, the side blocking assembly and the bottom plate enclose a mounting space;
wherein the box main body is configured to be cooperatively accommodated in the mounting space, and the box body and the fixing base are interconnected by a snap-fit structure provided therebetween.

2. The mounting and fixing system for photovoltaic junction box of claim 1, wherein the snap-fit structure comprises one or more groups of clasping members extending in an up-down direction, the clasping members are respectively snap-fitted with the box body, wherein all the clasping members are provided on one end of the bottom plate or are separately provided on both ends of the bottom plate.

3. The mounting and fixing system for photovoltaic junction box of claim 2, wherein the clasping members are respectively snap-fitted with the box main body, an upper portion of each of the clasping members has a first hook, and the box main body is provided with a cooperating part that is configured to be snap-fitted with the first hook.

4. The mounting and fixing system for photovoltaic junction box of claim 3, wherein the box main body comprises two side walls provided at two ends, the cooperating part is a first groove provided on the side walls, and the first hook is inserted into the first groove and abuts against a bottom wall of the first groove, and/or,
wherein the box main body comprises two side walls provided at two ends, the side wall comprises two side portions arranged in parallel and spaced apart, and a connecting rib connected between the two side portions, and the first hook is inserted between the two side portions and is clasped on the connecting rib.

5. (canceled)

6. The mounting and fixing system for photovoltaic junction box of claim 3, wherein the box main body comprises two side walls provided at two ends, the cooperating part is a skirt structure provided on the side wall and extending outwardly in a protruding manner, or, the cooperating part is a clasping hole provided on an outer side of the side wall and recessed inwardly, or, the cooperating part is a wedge-shaped structure provided on an outer side of the side wall and protruding outwardly.

7. The mounting and fixing system for photovoltaic junction box of claim 6, wherein a hook stop plate is further provided on an outer side of the clasping member, wherein the hook stop plate extends upward from the bottom plate, and the hook stop plate and the clasping member are spaced apart from each other,
wherein the hook stop plate and the side blocking assembly are integrally formed, and the side blocking assembly and the hook stop plate enclose a frame-shaped structure that is closed in a circumferential direction.

8. (canceled)

9. (canceled)

10. The mounting and fixing system for photovoltaic junction box of claim 2, wherein the box body further comprises an extension body extending away from the box main body, the extension body is provided at one or both ends of the box main body, a through hole extending in the up-down direction is formed between the extension body and the box main body, and the clasping member is configured to pass through the corresponding through hole in the up-down direction and be snap-fitted with the extension body or the box main body,
wherein the extension body comprises two extension parts arranged in parallel and spaced apart and a connecting part provided between the two extension parts, one end of the extension part is connected to a side wall of the box main body, and the through hole is formed between the two extension parts, the connecting part, and the box main body,
wherein the clasping member is snap-fitted with the extension body, wherein, when the clasping member passes through the through hole, the clasping member is snap-fitted with the connecting part,
wherein the clasping member has a second hook at an upper portion, and the second hook is cooperatively snap-fitted with the connecting part,
wherein the connecting part has an operating part, a fixing part, and a locking part connected in sequence in the up-down direction, wherein the fixing part is fixed to the extension part, the operating part and the locking part are respectively suspended on upper and lower sides of the extension part, and the clasping member is configured to be cooperatively snap-fitted with the locking part.

11. (canceled)

12. (canceled)

13. (canceled)

14. (canceled)

15. The mounting and fixing system for photovoltaic junction box of claim 10, wherein the connecting part comprises a first connecting strip connected between the two extension parts, a second connecting strip extending in the up-down direction, and a third connecting strip connected between the first connecting strip and the second connecting strip, wherein an upper part, a middle part, and a lower part of the second connecting strip constitute the operating part, the fixing part, and the locking part in sequence, and the second connecting strip is located on a side of the first connecting strip facing the through hole,
wherein a lower end of the locking part has a third hook extending toward the through hole, and when the clasping member is snap-fitted with the connecting part, the second hook and the third hook are hooked and fixed to each other.

16. (canceled)

17. The mounting and fixing system for photovoltaic junction box of claim 2, wherein the box body further comprises an extension body extending away from the box main body, the extension body is provided at one or both ends of the box main body, the clasping member is snap-fitted with the extension body, wherein the clasping member and the box main body are provided on different sides of the extension body,
wherein the extension body comprises two extension parts arranged in parallel and spaced apart and a connecting part provided between the two extension parts, one end of the extension part is connected to a side wall of the box main body, and the clasping member is snap-fitted with the connecting part.

18. (canceled)

19. (canceled)

20. (canceled)

21. (canceled)

22. (canceled)

23. (canceled)

24. (canceled)

25. (canceled)

26. (canceled)

27. The mounting and fixing system for photovoltaic junction box of claim 1, wherein the snap-fit structure is provided between the side blocking assembly and the box main body and is used to snap-fit the two together,
wherein the snap-fit structure comprises a buckling member having a snap-fitting part, and a buckling part configured to be cooperatively snap-fitted with the snap-fitting part, one of the buckling member and the buckling part is provided on the box main body and the other is provided on the side blocking assembly, and when the box main body is accommodated in the mounting space, the buckling member is located outside the mounting space,
wherein the buckling member extends in the up-down direction, the buckling member comprises an operating section, a fixing section, and a locking section connected in sequence in the up-down direction, the fixing section is attached to the box main body, and both the operating section and the locking section are spaced apart from an outer wall of the box main body, the snap-fitting part is provided at a lower part of the locking section, and the operating section is suspended above the box main body;
or, the buckling member extends in the up-down direction, the buckling member comprises a locking section, a fixing section, and an operating section connected in sequence in the up-down direction, the fixing section is attached to the side blocking assembly, and both the operating section and the locking section are spaced apart from an outer wall of the side blocking assembly, the snap-fitting part is provided at an upper part of the locking section, and a lower part of the operating section is suspended below the side blocking assembly.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. The mounting and fixing system for photovoltaic junction box of claim 1, wherein the box main body is configured to achieve cooperation with the mounting space when moving in a horizontal direction relative to the fixing base, and the snap-fit structure is provided between the side blocking assembly and the box body,
wherein the box body further comprises two extension bodies separately provided at two ends of the box main body and extending away from the box main body, the side blocking assembly has an engaging slot, the engaging slot has a side opening facing one side in the horizontal direction of the fixing base, and the extension body is configured to be cooperatively engaged in the engaging slot,
wherein the side blocking assembly comprises two spaced-apart side blocks, each of the side blocks is provided with the engaging slot, and when the box main body is located in the mounting space, the two extension bodies are correspondingly engaged in the two engaging slots.

40. (canceled)

41. (canceled)

42. The mounting and fixing system for photovoltaic junction box of claim 28, wherein the side openings of the two engaging slots face the same side of the fixing base, and the box main body is configured to cooperate with the mounting space in the process of translating horizontally relative to the fixing base,
wherein each of the side blocks comprises a first side blocking part provided with the engaging slot, and a second side blocking part connected to the first side blocking part, the first side blocking part and the second side blocking part form an L-shape, wherein the box main body has two oppositely arranged first side portions and two oppositely arranged second side portions, and the second side blocking parts of the two side blocks are both located on the same side of one of the first side portions,
wherein a length of the first side portion is greater than a length of the second side portion, and along an extension direction of the first side portion, the box main body is located between the two first side blocking parts.

43. (canceled)

44. (canceled)

45. The mounting and fixing system for photovoltaic junction box of claim 39, wherein the side openings of the two engaging slots face opposite directions, and the box main body is configured to cooperate with the mounting space in the process of rotating horizontally relative to the fixing base,
wherein each of the side blocks further comprises a second side blocking part connected to the first side blocking part, the first side blocking part and the second side blocking part form an L-shape, wherein the box main body has two oppositely arranged first side portions and two oppositely arranged second side portions, the second side blocking parts of the two side blocks are separately provided on different sides of the two first side portions, and a sum of lengths of the two second side blocking parts is less than a length of the first side portion.

46. (canceled)

47. (canceled)

48. The mounting and fixing system for photovoltaic junction box of claim 1, wherein the bottom plate has a central plate body located on an inner side of the side blocking assembly, and/or an extension plate body extending outward from an outer wall of the side blocking assembly.

49. (canceled)

50. (canceled)

51. A rapid mounting and fixing system for a smart photovoltaic junction box, comprising:
a fixing base and a smart photovoltaic junction box, wherein the fixing base comprises a main body with an open top, the main body is provided with a cavity for accommodating a box body of the smart photovoltaic junction box, and is a side is provided with a plurality of hooks for cooperatively fixing with the smart photovoltaic junction box;
wherein the smart photovoltaic junction box comprises a box body, a side of the box body is provided with an engaging structure for cooperating with the hooks, and two ends of the box body of the smart photovoltaic junction box are connected with at least one group of photovoltaic connectors via cables; a bottom surface of the fixing base is fixed to a backsheet of a photovoltaic module.

52. The rapid mounting and fixing system for a smart photovoltaic junction box of claim 51, wherein the fixing base is a box-shaped structure with an open top or a frame-shaped structure,
wherein the engaging structure comprises a skirt structure protruding from a side of the box body, or a clasping hole recessed inwardly on an outer side of the box body, or a wedge-shaped structure protruding outwardly on a side of the box body.

53. (canceled)

54. (canceled)

55. The rapid mounting and fixing system for a smart photovoltaic junction box of claim 51, wherein the fixing base is an independent component, fixed to a module backsheet by adhesive,
wherein the fixing base and a box body of a conventional junction box are a single piece, and are pre-fixed and installed on a module backsheet by adhesive.

56. (canceled)

57. (canceled)

58. (canceled)

59. (canceled)

60. (canceled)

61. (canceled)

62. (canceled)

63. (canceled)

64. (canceled)

65. A mounting and fixing system for a smart photovoltaic junction box,
wherein the mounting and fixing system comprises:
a smart photovoltaic junction box and a fixing base, the smart photovoltaic junction box comprises a box body, connectors are connected to two ends of the box body via cables, wherein one group of connectors are respectively plugged into positive and negative connectors of a conventional junction box;
wherein the fixing base comprises a fixing base main body, two opposite sides of the fixing base main body are provided with hooks for buckling with the box body of the smart photovoltaic junction box, and the other two opposite sides are provided with recessed structures; a bottom surface of the fixing base is fixed to a backsheet of a photovoltaic module, and at a bottom of a side of the fixing base main body, a through drain port is provided.

66. (canceled)

67. (canceled)

68. The mounting and fixing system for a smart photovoltaic junction box of claim 65, wherein the fixing base is a frame-shaped structure, and a protruding edge structure extending outward is provided at a bottom of a frame, and the fixing base is fixed to a module backsheet by adhesive on a bottom surface of the protruding edge structure,
wherein the fixing base is a box-shaped structure with an open top, and a bottom surface of the fixing base is fixed to a module backsheet by adhesive.

69. (canceled)

70. (canceled)

71. (canceled)

72. (canceled)

73. (canceled)

74. (canceled)

75. (canceled)

76. The mounting and fixing system for photovoltaic junction box of claim 2, wherein the box body further comprises an extension body extending away from the box main body, the extension body is provided at one or both ends of the box main body, the clasping member is snap-fitted with the extension body,
wherein the extension body comprises two extension parts arranged in parallel and spaced apart and a connecting part provided between the two extension parts, one end of the extension part is connected to a side wall of the box main body, the clasping member is snap-fitted with the connecting part.
